(19) United States
(12) Patent Application Publication
(10) Pub. No.: US 2023/0300645 A1
(43) Pub. Date: Sep. 21, 2023

(54) METHODS AND APPARATUS FOR BEAM FAILURE RECOVERY

(71) Applicant: InterDigital Patent Holdings, Inc., Wilmington, DE (US)

(72) Inventors: Young Woo Kwak, Woodbury, NY (US); Moon IL Lee, Melville, NY (US); Virgil Comsa, Montreal (CA); Nazli Khan Beigi, Longueuil (CA)

(21) Appl. No.: 18/019,222

(22) PCT Filed: Aug. 5, 2021
(86) PCT No.: PCT/US2021/044722

§ 371 Date: Feb. 1, 2023

Related U.S. Application Data
(60) Provisional application No. 63/061,753, filed on Aug. 5, 2020.

(51) Int. Cl. H04W 24/08; H04L 5/00

(52) U.S. Cl. CPC H04W 24/08; H04L 5/005

(57) ABSTRACT

Methods and apparatus for beam failure recovery (BFR) in wireless communications are provided. In an example, a method includes receiving configuration information of a set of reference signals (RSs) for monitoring and a set of candidate RSs for new beam selection, determining whether a number of the set of RSs is larger than a threshold, determining whether at least a subset of RSs of the set of RSs is failed, selecting at least a first RS and a second RS from the set of candidate RSs, based on the number of the set of RSs being larger than the threshold and at least the subset of RSs of the set of RSs being failed, transmitting a first uplink signal using a first uplink resource associated with the selected first RS, and/or transmitting a second uplink signal using a second uplink resource associated with the selected second RS.

### CROSS-REFERENCE TO RELATED APPLICATION(S)

This application claims priority to and the benefit of U.S. Provisional Application No. 63/061,753 filed in the U.S. Patent and Trademark Office on Aug. 5, 2020, the entire contents of which being incorporated herein by reference as if fully set forth below in its entirety and for all applicable purposes.

### SUMMARY

Embodiments disclosed herein generally relate to communication networks, wireless and/or wired. For example, one or more embodiments disclosed herein are related to methods and apparatus for beam failure recovery (BFR) in wireless communications (e.g., in high frequencies).

In one embodiment, a method implemented by a wireless transmit/receive unit (WTRU) for wireless communications includes receiving configuration information of a set of reference signals (RSs) for monitoring and a set of candidate RSs for new beam selection, determining whether a number of the set of RSs is larger than a threshold, determining whether at least a subset of RSs of the set of RSs is failed, and selecting at least a first RS and a second RS from the set of candidate RSs, based on a determination that 1) the number of the set of RSs is larger than the threshold and 2) at least the subset of RSs of the set of RSs is failed (e.g., all-beam/all-RSs failure). The method may also include transmitting a first uplink signal using a first uplink resource associated with the selected first RS, and/or transmitting a second uplink signal using a second uplink resource associated with the selected second RS.

In one embodiment, a WTRU comprising a processor, a transmitter, a receiver, and/or memory may be configured to implement the method disclosed herein. For example, the WTRU may be configured to receive configuration information of a set of reference signals (RSs) for monitoring and a set of candidate RSs for new beam selection, determine whether a number of the set of RSs is larger than a threshold, determine whether at least a subset of RSs of the set of RSs is failed, and select at least a first RS and a second RS from the set of candidate RSs, based on a determination that 1) the number of the set of RSs is larger than the threshold and 2) at least the subset of RSs of the set of RSs is failed (e.g., all-beam/all-RSs failure). The WTRU may be further configured to transmit a first uplink signal using a first uplink resource associated with the selected first RS, and/or transmit a second uplink signal using a second uplink resource associated with the selected second RS.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures and the detailed description are not to be considered limiting, and other equally effective examples are possible and likely. Furthermore, like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a flow chart illustrating an exemplary beam failure recovery (BFR) procedure, according to one or more embodiments;

FIG. 3 is a flow chart illustrating an exemplary BFR procedure for a Secondary Cell (SCell), according to one or more embodiments;

FIG. 4 is a diagram illustrating an example of comparison of pathloss, beam width and beam gain in 28 GHz and 100 GHz, according to one or more embodiments;

FIG. 5 is a diagram illustrating an example of a wireless communications system having higher beam mismatch due to narrow beam width(s) in higher frequencies, according to one or more embodiments;

FIG. 6 is a flow chart illustrating an example of a BFR procedure including operations of all beam-BFR and partial beam-BFR, according to one or more embodiments;

FIG. 7 is a flow chart illustrating an example of beam failure detection with independent BFR counters for a hybrid operation of partial beam-BFR and all beam-BFR, according to one or more embodiments;

FIG. 8 is a diagram illustrating an example of sequential transmission of multiple uplink resources with a timer and/or a counter, according to one or more embodiments;

FIG. 9 is a diagram illustrating an example of sequential transmission of multiple uplink resources with multiple timers and/or multiple counters, according to one or more embodiments; and

FIG. 10 is a diagram illustrating an example of group-based beam/resource utilization for a BFR operation, according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Communications Networks and Devices

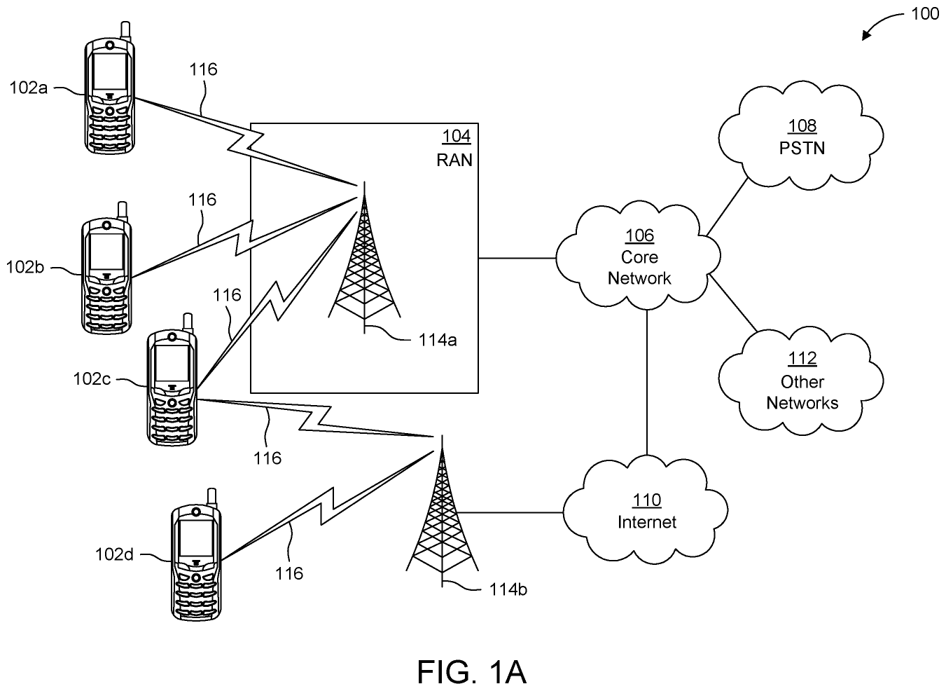

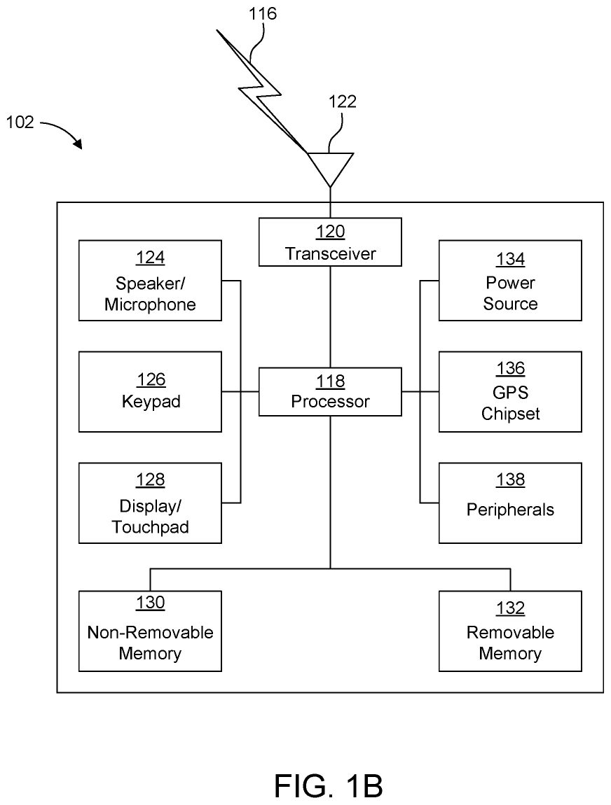

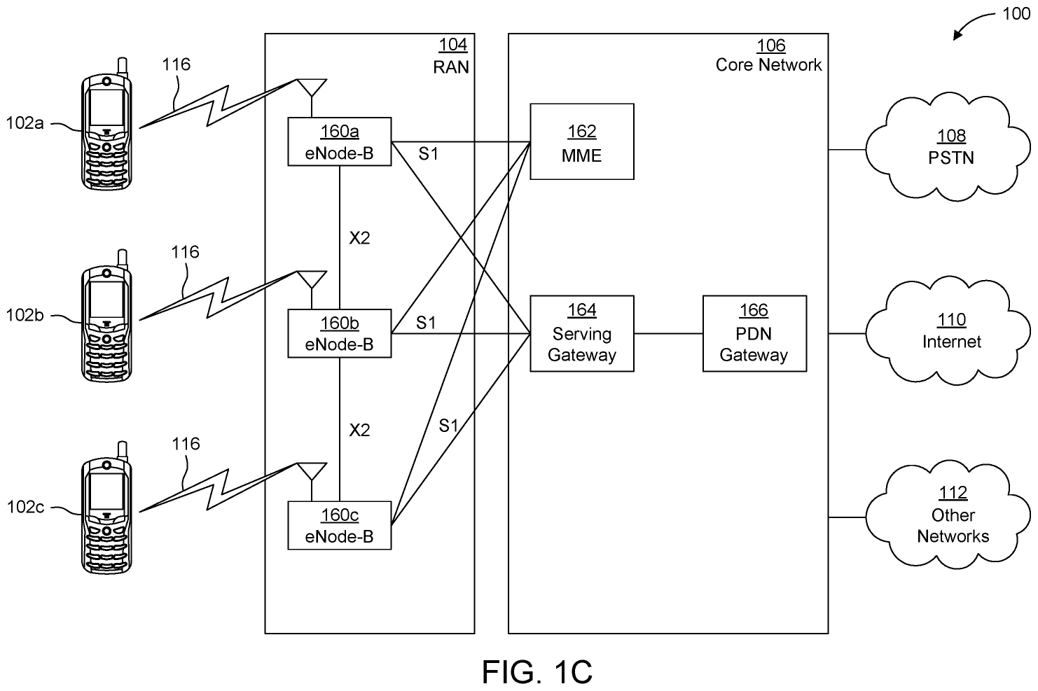

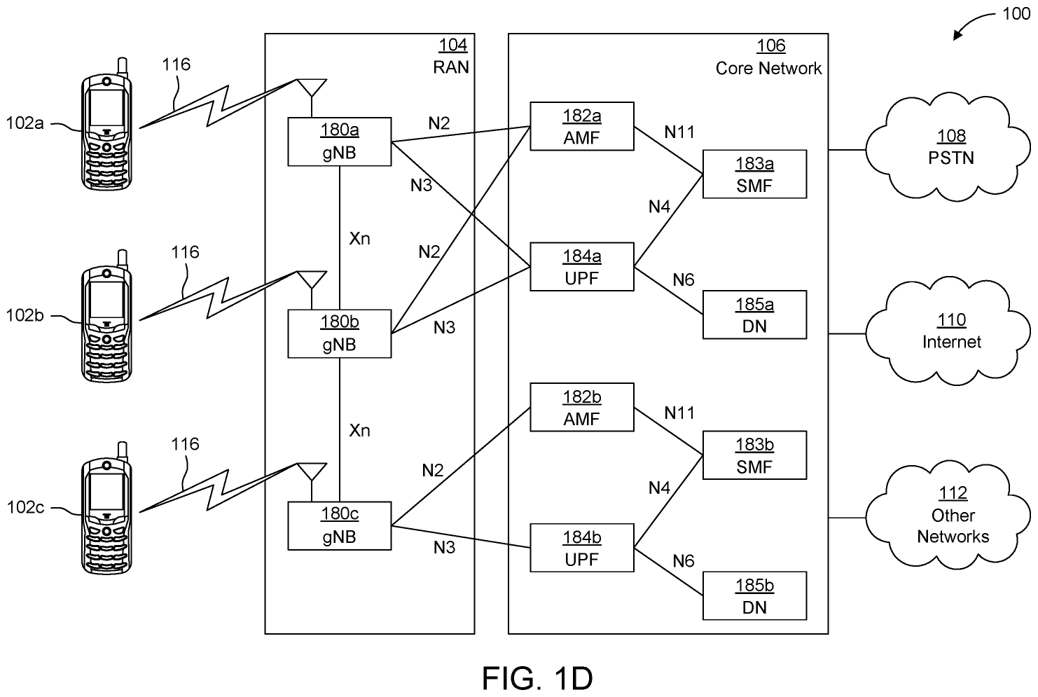

The methods, apparatuses and systems provided herein are well-suited for communications involving both wired and wireless networks. Wired networks are well-known. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a New Radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, e.g., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (e.g., Wireless Fidelity (WiFi), IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, a Home Node B, a Home eNode B, or an access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR, etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AM F) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 182 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Beam Failure Recovery (BFR)

Primary Cell (PCell) BFR in New Radio (NR)

For radio link monitoring (RLM) (e.g., in NR Rel-15), a WTRU may continuously perform channel quality measurements of a serving cell to assert whether the network is able to reach the WTRU with control channel transmission(s). In some examples, when link quality is lower than a certain threshold, the WTRU may initiate a contention-based RACH procedure and trigger a high-layer reconnection procedure. The high-layer reconnection procedure may include, for example, initiating a new cell re-selection and/or a radio resource configuration (RRC) reconfiguration which are quite costly.

Since beams in Frequency Range 2 (FR2) are narrow, beam tracking may dynamically fail (e.g., blockage by a moving object). In this case, initiating contention-based RACH and performing cell re-selection may be unnecessary since another beam from the same cell may be used to reach the WTRU. A physical layer procedure to recover the dynamic failure of the beam may be a beam failure recovery (BFR) in NR.

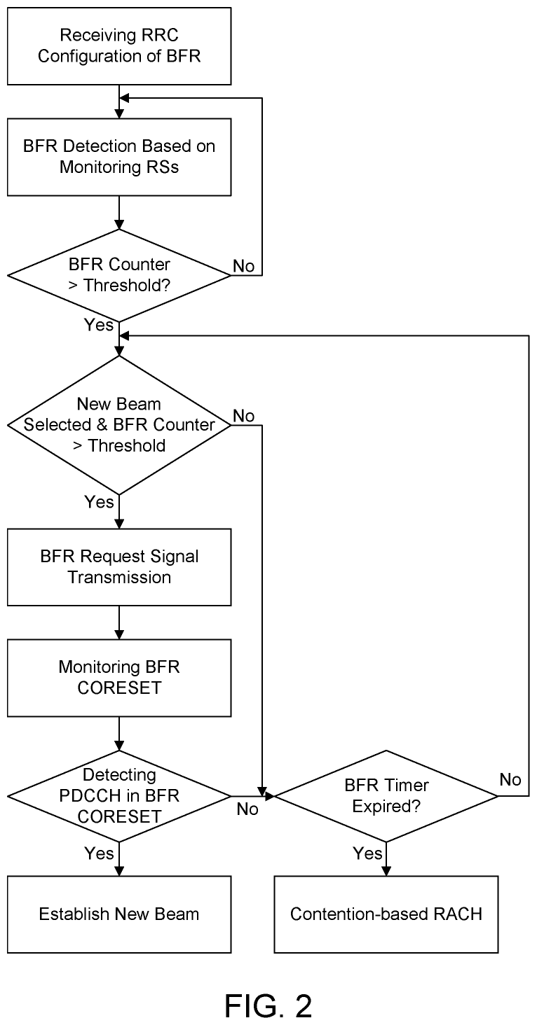

In a BFR procedure, referring to FIG. 2, the WTRU may continuously monitor a set of WTRU-specific periodic reference signals (RSs) (e.g., SSB and/or CSI-RS) associated with transmit (TX) beams associated with control channel transmissions. For example, for each bandwidth part (BWP) of a serving cell, the WTRU may be provided a set (q̅₀) of periodic Channel State Information-Reference Signal (CSI-RS) resource configuration indexes and/or SS/PBCH block indexes by failureDetectionResources. In another example, if the WTRU is not provided failureDetectionResources, the WTRU may determine the set q̅₀ to include periodic CSI-RS resource configuration indexes with same values as the RS indexes in the RS sets (indicated by TCI-State for respective Control Resource SETs (CORESETs) that the WTRU uses for monitoring Physical Downlink Control Channel (PDCCH)). If there are two RS indexes in a TCI state, the set q̅₀ may include RS indexes with QCL-TypeD configuration for the corresponding TCI states. When the measured beam quality of all WTRU-specific periodic RSs of the set q̅₀ becomes low, the WTRU may declare s beam link failure procedure and may identify one or more alternative candidate TX beams. In an example of a BFR mechanism, a WTRU may detect beam failure(s) when all RSs of the set q̅₀ becomes lower than a threshold (e.g., all beam-BFR disclosed herein).

In some examples, one or more alternative candidate TX beams may be selected from a set of WTRU-specific periodic RSs (e.g., SSB and/or CSI-RS). For example, for each BWP of a serving cell, the WTRU may be provided, a set (q̅₁) of periodic CSI-RS resource configuration indexes and/or SS/PBCH block indexes by candidateBeamRSList in an RRC configuration for radio link quality measurements on the BWP of the serving cell.

In order to monitor the WTRU-specific RSs and select the alternative candidate TX beam(s), a WTRU may be provided a hypothetical Block Error Rate (BLER) threshold and/or a Reference Signal Received Power (RSRP) threshold in RRC configuration. For example, the WTRU may be provided the thresholds Q_{out,LR} and Q_{in,LR} correspond to the default value of dmInSyncOutOfSyncThreshold and to the value provided by rsrp-ThresholdSSB, respectively. Based on the thresholds, the WTRU may assess the radio link quality. For example, the WTRU may assess the radio link quality according to the set q̅₀ of resource configurations against the threshold Q_{out,LR}. In another example, the WTRU may apply the Q_{in,LR} threshold to the L1-RSRP measurement obtained from a SS/PBCH block and/or a CSI-RS resource after scaling a respective CSI-RS reception power with a value provided by powerControlOffsetSS.

After finding a new beam, the WTRU may transmit a beam recovery request message via a dedicated channel (e.g., a physical random access channel (PRACH)) to the serving cell. The WTRU may provide the periodic CSI-RS configuration indexes and/or SS/PBCH block indexes from the set q̅₁ and the corresponding L1-RSRP measurements that are larger than or equal to the Q_{in,LR} threshold. The report of the periodic CSI-RS configuration indexes and/or SS/PBCH block indexes may be based on associations between PRACH resources and periodic CSI-RS configuration indexes and/or SS/PBCH block indexes. For example, the WTRU may receive, via PRACH-ResourceDedicatedBFR, a configuration for PRACH transmission.

After receiving the PRACH, the network (e.g., a gNB) may transmit a recovery response to the WTRU. For example, the WTRU may be provided a CORESET through a link to a search space set (e.g., provided by recoverySearchSpaceId in RRC configuration for monitoring PDCCH in the CORESET), and the network may transmit PDCCH through the CORESET and/or the search space set. If the WTRU successfully receives the response, the beam recovery procedure may be successful, and a new beam pair link may be established. Otherwise, the WTRU may perform one or more additional beam recovery requests. If an additional beam recovery procedure (or request) still fails, the WTRU may initiate a contention-based RACH procedure, which may include a cell re-selection.

In some examples, initialization of BFR procedure may be based on a BFR counter. For example, a WTRU may be provided a counter (e.g., a beamFailureInstanceMaxCount) in an RRC configuration for the BFR procedure from the network (e.g., a gNB). The WTRU may count the number of beam failures by using a counter (e.g., BFI_COUNTER). In an example, the initial value of the counter may be zero (0). When a beam failure of the WTRU occurs, the WTRU may increment the counter by one (1). If the counter is lower than a threshold (e.g., beamFailureInstanceMaxCount), the WTRU may not report the beam failure(s) to the network (e.g., the gNB). If the counter is equal to the threshold or larger than the threshold, the WTRU may report the beam failure(s) (e.g., transmitting a PRACH) to the network (e.g., the gNB). The counter may be based on a beam failure detection timer. For example, the WTRU may be provided a beamFailureDetectionTimer. When a first beam failure of the WTRU occurs, the WTRU may start the beam failure detection timer. When the beam failure detection timer expires, the WTRU may reset the counter (e.g., set the counter to zero (0)).

In some examples, a BFR procedure may include using a BFR timer (e.g., refer to FIG. 2). For example, a WTRU may be provided a BFR timer (e.g., a beamFailureRecoveryTimer) in an RRC configuration from the network (e.g., a gNB). The WTRU may start the BFR timer when the WTRU starts random access procedure to transmit PRACH for BFR. When the BFR timer expires, the WTRU may stop the BFR procedure and initiate/start a contention-based RACH procedure.

Secondary Cell (SCell) BFR in NR

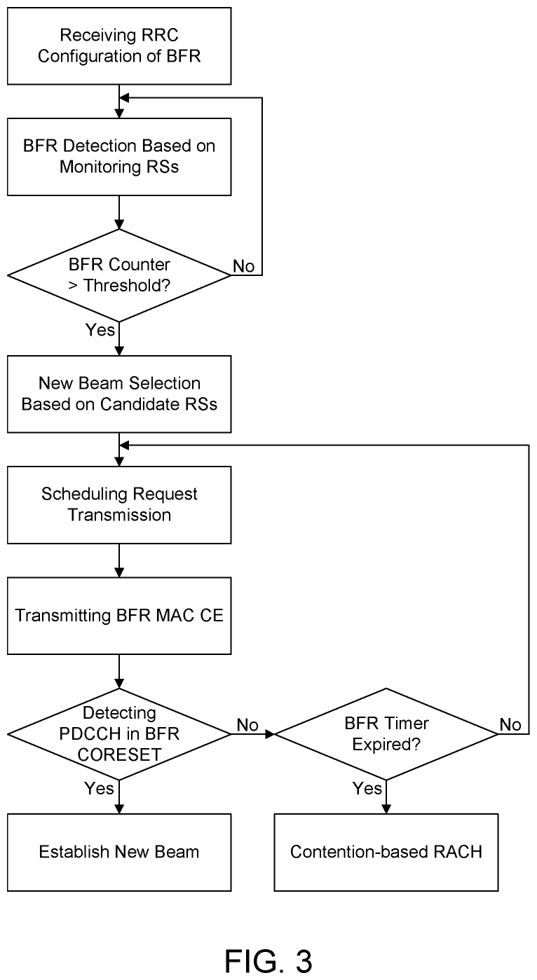

In NR (e.g., NR Rel-16), a WTRU may support BFR procedures for one or more Secondary Cells (SCells). For example, referring to FIG. 3, in an SCell BFR procedure, a WTRU may continuously monitor a set of WTRU-specific periodic RSs (e.g., SSB and/or CSI-RS) associated with TX beams, and the TX beams are associated with control channel transmissions. In an example, the WTRU may be provided, a set (q̅₀) of periodic CSI-RS resource configuration indexes and/or SS/PBCH block indexes for one or more SCells. In another example, if the WTRU is not provided the set (q̅₀) of periodic CSI-RS resource configuration indexes and/or SS/PBCH block indexes for the one or more SCells, the WTRU may determine the set q̅₀ to include periodic CSI-RS resource configuration indexes, and the periodic CSI-RS resource configuration indexes may have same values as the RS indexes in the RS sets (indicated by TCI-State for respective CORESETs that the WTRU uses for monitoring PDCCH). If there are two RS indexes in a TCI state, the set q̅₀ may include RS indexes with QCL-TypeD configuration for the corresponding TCI states. When the measured beam quality of all WTRU-specific periodic RSs of the set q̅₀ becomes low, the WTRU may declare a beam link failure procedure and may identify one or more alternative candidate TX beams.

In some examples, one or more alternative candidate TX beams may be selected from a set of WTRU-specific periodic RSs (e.g., SSB and/or CSI-RS). For example, the WTRU may be provided, for each BWP of a serving cell, a set q̅₁ of periodic CSI-RS resource configuration indexes and/or SS/PBCH block indexes (e.g., via candidateBeamRSSCellList-r16) in an RRC configuration for radio link quality measurements on the BWP of the serving cell.

In order to monitor the WTRU-specific RSs and select one or more alternative candidate TX beams, a WTRU may be provided a hypothetical BLER threshold and an RSRP threshold in an RRC configuration. For example, the WTRU may be provided the thresholds Q_{out,LR} and Q_{in,LR} correspond to the default value of rImInSyncOutOfSyncThreshold and to the value provided by rsrp-ThresholdBFR-r16, respectively. Based on the thresholds, the WTRU may assess the radio link quality. For example, the WTRU may assess the radio link quality according to the set q̅₀ of resource configurations against the threshold Q_{out,LR}. In another example, the WTRU may apply the Q_{in,LR} threshold to the L1-RSRP measurement obtained from a SS/PBCH block and/or a CSI-RS resource after scaling a respective CSI-RS reception power with a value provided by powerControlOffsetSS.

After finding a new beam, a WTRU may transmit one or more scheduling requests (SRs) to the network (e.g., a gNB). A resource to transmit the one or more SRs for SCell BFR may be preconfigured in an RRC configuration. For example, the WTRU may be provided schedulingRequestID-BFR-SCell-r16 in an RRC configuration from a gNB. Based on information of the schedulingRequestID-BFR-SCell-r16, the WTRU may transmit the one or more SRs and may receive PDCCH scheduling uplink resource to transmit one or more Medium Access Control Control Element (MAC CE) messages to the gNB. If the WTRU is not provided the resource to transmit the one or more SRs, the WTRU may transmit the one or more SRs in other PUCCH resources for normal SRs (e.g., SRs for uplink eMBB transmissions).

In some examples, a WTRU may support a BFR MAC CE to report BFR and/or selected beams to the network (e.g., a gNB). The BFR MAC CE may indicate one or more SCells which are experiencing beam failure(s). For the one or more SCells, the BFR MAC CE may report or indicate zero (e.g., when measurement of all monitoring RSs for a SCell less than a predetermined threshold) or more new candidate beams.

### NR in High Frequencies

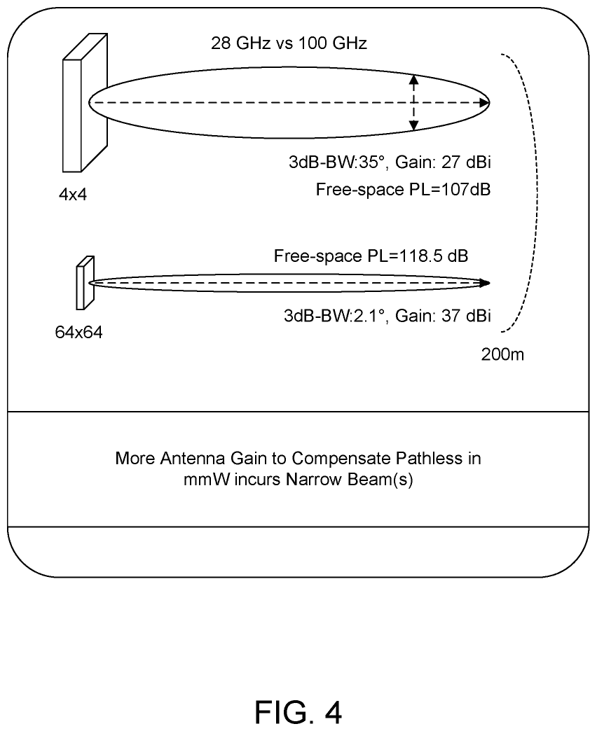

Pathloss is reduction in power density of an electromagnetic wave as the wave propagates through space. Pathloss increases as carrier frequency increases. For example, referring to FIG. 4, in higher frequencies (e.g., above 52.6 GHz), pathloss of above 52.6 GHz is more than 10 dB larger than Frequency Range 2 (FR2, i.e., 28 GHz). In order to overcome high pathloss in higher frequencies, enhanced beam gain (e.g., 10 dB) is needed, but the enhanced beam gain brings narrower beam width (e.g., 35 degree to 3 degree). As beam width becomes narrower, larger number of beams are needed to maintain cell coverage.

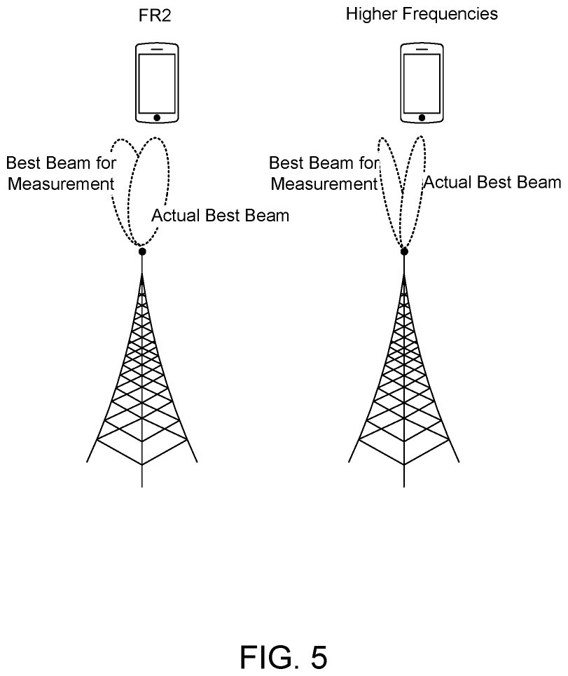

Referring to FIG. 5, due to narrower beam width in higher frequencies, beam measurement, beam reporting and beam indication from a WTRU and a gNB may have larger mismatch compared to FR2. For example, when a WTRU is in a medium or high mobility situation, optimal beam direction may change in higher frequencies. For FR2, due to relatively larger beam width, reduction of signal strength due to beam direction change may be limited and previously indicated beam may be applicable with endurable amount of signal loss. For higher frequencies, however, previously indicated beam may not be applicable due to significantly low signal power.

In high frequency ranges, such as gigahertz (GHz) and/or Terahertz (THz), beams are narrowing down dramatically with a lower coverage due to high pathloss of the frequency ranges, and therefore the WTRU has to be fast to perform BFR and uses a reliable beam change process. However, in NR (e.g., NR Rel-15), BFR only supports a dynamic recovery mechanism when all monitoring beams (e.g., beams that monitor for PDCCH) fail in FR2 (e.g., all beam-BFR). The application of only all beam-BFR for higher frequencies (e.g., above 52.6 GHz) may have some issues. For example, some current all beam-BFR procedure may not provide enough reliability due to narrower beam width. For example, when all monitoring beams fail, all candidate beams would fail due to narrow beam width and limited number of beams. In another example, increasing the number of monitoring beams and/or candidate beams to provide better reliability for higher frequencies may be possible. However, due to a larger number of beams, the complexity of WTRU to measure monitoring RSs and selection of candidate RSs become much severe. For some unlicensed operations, PRACH transmission to report beam failure may not be possible considering Listen-Before-Talk (LBT) operation.

### Representative Beam Failure Recovery (BFR) Procedures

In various embodiments, a WTRU and/or a gNB may enable reliable BFR procedure(s) by supporting hybrid operation(s) of all beam-BFR and partial beam-BFR for higher frequencies. In various embodiments, a WTRU and/or a gNB may enable a hybrid operation of a beam management procedure and a BFR procedure to provide better reliability. In various embodiments, a WTRU and/or a gNB may enable a PRACH resource selection for BFR based on a BFR case (e.g., a use case). In various embodiments, a WTRU and/or a gNB may enable efficient resource utilization of resources for BFR. In various embodiments, a WTRU and/or a gNB may enable a reliable BFR procedure by supporting or using beam group-based reporting for BFR.

In various embodiments, a beam reporting may be interchangeably referred to as (or used with) a beam indication, new candidate beam reporting, and/or new candidate beam indication for beam failure recovery. In various embodiments, a beam failure detection may be interchangeably referred to (or used with) as a beam failure indication. In various embodiments, search spaces may be interchangeably referred to as (or used with) CORESETs.

Definition of Beam

In various embodiments, a WTRU may transmit or receive a physical channel or reference signal according to at least one spatial domain filter. The term “beam” may be used to refer to a spatial domain filter. The WTRU may transmit a physical channel or signal using the same spatial domain filter as the spatial domain filter used for receiving an RS (such as CSI-RS) or a SS block. The WTRU transmission may be referred to as “target”, and the received RS or SS block may be referred to as “reference” or “source”. In an example, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may transmit the first (target) physical channel or signal according to a spatial relation with a reference to the second (reference) physical channel or signal.

A spatial relation may be implicit, configured by RRC or signaled by MAC CE or Downlink Control Information (DCI). For example, a WTRU may implicitly transmit PUSCH and Demodulation Reference Signal (DM-RS) of PUSCH, according to the same spatial domain filter as an SRS indicated by an SRS resource indicator (SRI), which may be indicated in DCI or configured by RRC. In another example, a spatial relation may be configured by RRC for an SRI or signaled by MAC CE for a PUCCH. The spatial relation may be referred to as a “beam indication.”

In various embodiments, the WTRU may receive a first (target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the WTRU is configured with a quasi-colocation (QCL) assumption type-D between corresponding antenna ports. Such association may be configured as a TCI (transmission configuration indicator) state. A WTRU may be indicated an association between a CSI-RS resource (or SS block) and a DM-RS by an index (or a TCI state) configured by RRC and/or signaled by MAC CE. In some examples, the index (e.g., configured by RRC and/or signaled by MAC CE) may be one of a set of indexes that are associated with one or more TCI states of a set of TCI states. For example, the index may be associated with multiple TCI states. The indication may be referred to as a “beam indication.”

Hybrid Operation of Partial Beam BFR and all Beam BFR

In various embodiments, a WTRU may measure beam quality based on a reference signal associated with the beam, and the beam quality measurement may include at least one of: L1-RSRP, L1-SINR, Channel Quality Indicator (CQI), and/or a radio link quality (e.g., hypothetical BLER of a DL/UL physical channel). Beam quality may be measured from a reference signal (e.g., a beam reference signal) associated with CORESETs in the active BWP, for which a WTRU may be monitoring.

In various embodiments, beam reporting may be used by a WTRU to indicate (e.g., to a gNB) a preferred beam at the WTRU (e.g., a UE) side. One or more of the following operations may be used for beam reporting:
Explicit indication:
   A WTRU may indicate a beam index to a gNB using an uplink physical channel (e.g., PUCCH, PUSCH, or PRACH), and the uplink physical channel may carry the bit information of the beam index.
Implicit indication:
   A WTRU may indicate a beam index to a gNB implicitly, and the beam index may be indicated by selecting an uplink resource. For example, the WTRU may be configured with a set of uplink resources, and each resource of the set may be associated with a beam. By sending a signal on the selected resource from the set of uplink resources, a beam index or beam information may be indicated to a gNB.
      For example, one or more PRACH resources may be configured and each PRACH resource may be associated with a new candidate beam index. A WTRU may send a PRACH in the PRACH resource associated with the determined candidate beam index.
   A WTRU may indicate a beam index to gNB implicitly by selecting a sequence. For example, a set of sequences may be used, and each sequence may be associated with a beam. A WTRU may determine a sequence based on the selected new candidate beam index.
   A WTRU may indicate an RS index, an RS resource index and/or an RS resource set index, wherein RS may indicate SSB and/or any of RS in NR (e.g., CSI-RS, Tracking Reference Signal (TRS), DM-RS, SRS, Phase Tracking Reference Signal (PT-RS), Positioning Reference Signal (PRS), and etc.).

In various embodiments, one or more of following configurations may be used for beam failure recovery (BFR):
A WTRU may be configured with one or more of beam failure detection (BFD) RSs (e.g., go)
   The configuration of BFD-RSs may be based on explicit configuration by a gNB.
   The configuration of the BFD-RSs may be based on implicit configuration. For example, if a WTRU does not receive explicit configuration of the BFD-RSs, the WTRU may determine the one or more sets of BFD-RSs based on one or more RSs with QCL Type-D in configured TCI states for PDCCH reception.
A WTRU may be configured with one or more counters and one or more maximum numbers of the one or more counters. The counters may be one or more of following:
   BFD counters and thresholds for the BFD counters.
   Beam reporting counters and thresholds for the beam reporting counters.
   Preamble power ramping counter and thresholds for preamble power ramping counter.
   In one embodiment, if a counter (e.g., for one or BFD counter, beam reporting counter or preamble power ramping counter) and a threshold are configured, the counter and the threshold may be for all beam-BFR. If multiple counters (e.g., for one of BFD counter, beam reporting counter or preamble power ramping counter) and multiple thresholds are configured, a counter of the multiple counters and a threshold of the multiple thresholds may be for all beam-BFR. Other counters of the multiple counters and other thresholds of the multiple thresholds may be for partial beam—BFR.
      The number of configured counters and number of configured thresholds may be the same.
A WTRU may be configured with one or more timers. The one or more timers may be any of the following:
   Beam Failure Detection (BFD) timers;
   BFR timers; and
   In one embodiment, if a timer (e.g., a BFI timer, BFD timer or BFR timer) is configured, the timer may be for all beam-BFR. If multiple timers are configured, a timer of the multiple timers may be for all beam-BFR. Other timers of the multiple timers may be for partial beam-BFR.
A WTRU may be configured with one or more sets of new candidate beam (NCB) RSs (e.g., q̅₁).
   Each RS of NCB-RSs may be associated with one or more uplink resources (e.g., PRACH, PUCCH, PUSCH, and/or SRS).
A WTRU may be configured with uplink resources (S) for new candidate beam indication, where S is one or more uplink resources to indicate new candidate beam.
A WTRU may be configured with search spaces (C) for receiving one or more confirmation random access response of BFR, where Cᵢ is a set of search spaces to receive random access response for BFR.

### Hybrid Operation of all Beam-BFR and Partial Beam-BFR

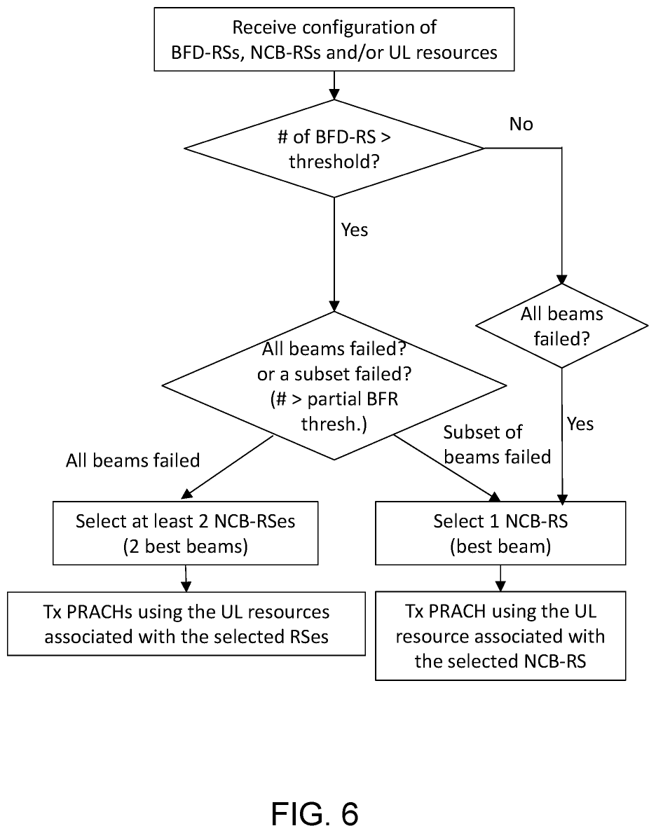

In one embodiment, a WTRU may support a hybrid operation of all beam-beam failure recovery (BFR) and partial beam-BFR. For example, referring to FIG. 6, the WTRU may process a first procedure (e.g., all beam-BFR) for beam recovery if all BFD-RSs fail (e.g., measurements of all BFD RSs are below a threshold). If a number of failed BFD-RSs is larger than a threshold but less than a number of configured BFD-RSs, the WTRU may process a second procedure (e.g., partial beam-BFR). The threshold may be based on a predefined value, an RRC configured value by a gNB and/or a reported value by the WTRU.

### Mode of Operation for a Hybrid Operation of Partial Beam-BFR and all Beam-BFR

In various embodiments, one or more of modes of operation may be used for beam failure recovery request(s). The number of BFD counters may be determined based on the mode of operation. One or more of following operations may apply:
A mode of operation may be determined based on a set of configured counters and corresponding thresholds.
   For example, for each counter type (e.g., a BFD counter, a beam reporting counter, or a preamble power ramping counter), if a WTRU is configured with a single counter and a single threshold, the WTRU may determine the mode of operation as a first mode of operation (e.g., all beam-BFR). If the WTRU is configured with multiple counters (e.g., for each counter type) and multiple thresholds, the WTRU may determine the mode of operation as a second mode of operation (e.g., hybrid operation of all beam-BFR and partial beam-BFR).
A mode of operation may be determined based on a number of configured timers.
   For example, for each timer type (e.g., a BFI timer, a BFD timer, or a BFR timer), if a WTRU is configured with a single timer, the WTRU may determine the mode of operation as a first mode of operation (e.g., all beam-BFR). If the WTRU is configured with multiple timers (e.g., for each timer type), the WTRU may determine the mode of operation as a second mode of operation (e.g., hybrid operation of all beam-BFR and partial beam-BFR).
A mode of operation may be determined based on a configuration of one or more threshold values (e.g., a preconfigured number of failed beams) for partial beam failure detection.
   For example, if a WTRU is not configured with the one or more threshold values (e.g., for partial beam failure detection), the WTRU may determine the mode of operation as a first mode of operation (e.g., all beam-BFR). If the WTRU is configured with one or more threshold values for partial beam failure detection, the WTRU may determine the mode of operation as a second mode of operation (e.g., hybrid operation of all beam-BFR and partial beam-BFR).
A mode of operation may be determined based on a configuration of one or more threshold values (e.g., a preconfigured number of failed beams) for partial beam failure reporting.
   For example, if a WTRU is not configured with the one or more threshold values (e.g., for beam reporting of partial beam-BFR), the WTRU may determine the mode of operation as a first mode of operation (e.g., all beam-BFR). If the WTRU is configured with one or more threshold values for partial beam failure reporting, the WTRU may determine the mode of operation as a second mode of operation (e.g., hybrid operation of all beam-BFR and partial beam-BFR) A mode of operation may be determined based on a WTRU measurement or WTRU reporting based on one or more of following:
RS quality (e.g., any of: RSRP, Signal-to-interference-plus-noise Ratio (SINR),
   Reference Signal Received Quality (RSRQ), and/or Received Signal Strength Indicator (RSSI)).
      For example, if a WTRU reports RS quality (e.g., via CSI reporting for beam management and/or RLM) higher than a threshold X, the WTRU may determine the mode of operation as a first mode of operation (e.g., all beam-BFR). If the WTRU reports RS quality (e.g., via CSI reporting for beam management and/or RLM) lower than (or equal to) a threshold X, the WTRU may determine the mode of operation as a second mode of operation (e.g., hybrid operation of all beam-BFR and partial beam-BFR).
   Modulation and Coding Scheme (MCS)
      For example, if a WTRU receives a PDCCH that schedules PDSCH and/or PUSCH with a MCS higher than a threshold X, the WTRU may determine the mode of operation as a first mode of operation (e.g., all beam-BFR). If a WTRU receives a PDCCH that schedules PDSCH and/or PUSCH with an MCS lower than (or equal to) a threshold X, the WTRU may determine the mode of operation as a second mode of operation (e.g., hybrid operation of all beam-BFR and partial beam-BFR).
   CQI
      For example, if a WTRU reports CQI (e.g., via CSI reporting) higher than a threshold X, the WTRU may determine the mode of operation as a first mode of operation (e.g., all beam-BFR). If the WTRU reports CQI (e.g., via CSI reporting) lower than (or equal to) a threshold X, the WTRU may determine the mode of operation as a second mode of operation (e.g., hybrid operation of all beam-BFR and partial beam-BFR).
A mode of operation may be determined based on a configuration of multi-transmission (e.g., for one or more of PDCCH, PDSCH, PUCCH, and PUSCH).
   For example, if a WTRU is not configured with multi-transmission (e.g., for one or more of PDCCH, PDSCH, PUCCH and PUSCH), the WTRU may determine the mode of operation as a first mode of operation (e.g., all beam-BFR). If the WTRU is configured with multi-transmission, the WTRU may determine the mode of operation as a second mode of operation (e.g., hybrid operation of all beam-BFR and partial beam-BFR).
A mode of operation may be determined based on a WTRU capability and gNB configuration based on the WTRU capability reporting.
A WTRU may request its preferred mode of operation for beam failure recovery. For example, if a WTRU is capable to support both modes of operation (e.g., all beam-BFR and hybrid operation of partial beam-BFR and all beam-BFR) and the measurements at a WTRU indicates a preferred mode of operation, the WTRU may indicate the preferred mode of operation to a gNB.
   For example, if beam quality measurements are less than (or higher than) a threshold, a WTRU may indicate a first mode of operation (e.g., hybrid operation of partial beam-BFR and all beam-BFR) as a preferred mode of operation. If the beam quality measurements are higher than (or less than) the threshold, the WTRU may indicate a second mode of operation (e.g., all beam-BFR).

### Interaction Between BFR Modes

In various embodiments, one or more BFR modes may be used (or configured, or determined, or selected) and an event of a BFR mode may trigger a procedure, operation, or WTRU behavior for another BFR mode. In an example, if a WTRU send a new candidate beam for a first BFR mode (e.g., all beam-BFR), the WTRU may reset the BFR counter for a second BFR mode (e.g., partial beam-BFR). In another example, if a WTRU send a beam failure incident to the upper layer from PHY layer for a first BFR mode, the WTRU may hold a BFR procedure for a second BFR mode. One or more of following operations may apply:
A default BFR mode may be used, configured, and/or selected. If an event is occurred for the default BFR mode, a WTRU may hold or pause BFR procedures for the rest of BFR modes (e.g., stop sending beam failure incident to upper layer).
   The event may include one or more of following:
      Beam failure incident is indicated to upper layer from PHY layer; The beam failure detection counter (e.g., beamFailureInstnceMaxCount) hits the maximum number;
      One or more new candidate beams have been sent to upper layer; and
      A WTRU received a DCI in a dedicated search space for BFR (e.g., a search space with recoverySearchSpaceId) which may be referred to as BFR search space hereafter.
   Pause of (or delay) a BFR mode or BFR procedure may include at least one of following:
      Stop monitoring beam reference signal(s) in q_{0,j};
      Stop sending beam failure incident to upper layer from PHY layer; and/or
      Stop sending new candidate beam(s) to a gNB.
If a WTRU receives a DCI in a BFR search space for the default BFR mode, the WTRU may resume BFR procedure(s) for the rest of BFR modes.

### Hybrid Operation of Partial Beam-BFR and all Beam-BFR

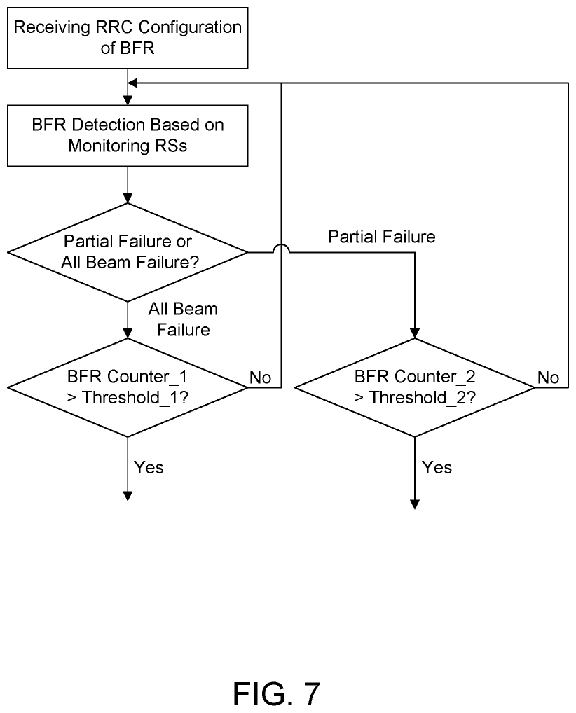

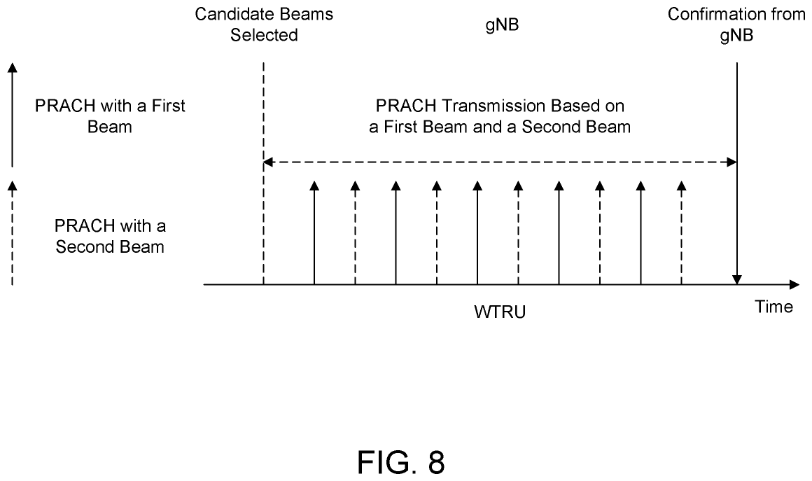

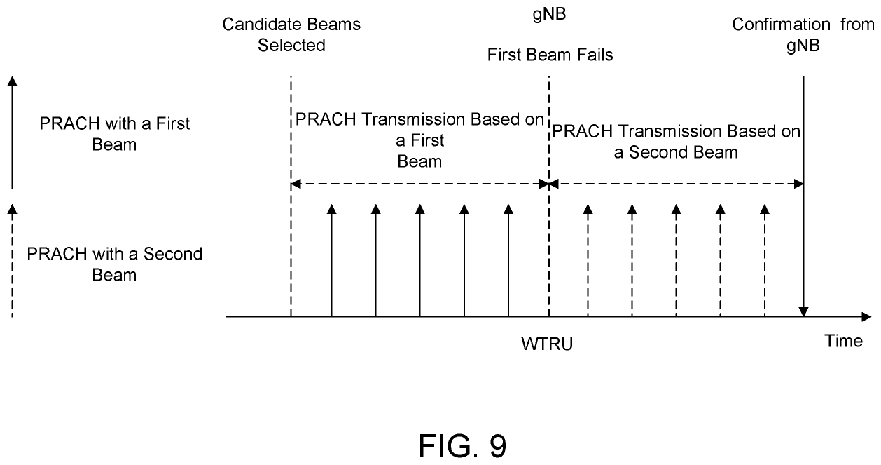

In one embodiment, a WTRU may support a hybrid operation of partial beam-BFR and all beam-BFR. Referring to FIG. 7, a beam failure detection with independent BFR counters for hybrid operation of partial beam-BFR and all beam-BFR is provided. The hybrid operation may be based on or include one or more of following operations/features:
Number of BFD-RSs for beam failure detection.
   The WTRU may be configured with one or more numbers of BFD-RSs for beam failure detection of partial beam-BFR (e.g., via RRC and/or MAC CE). Based on the configured numbers of BFD-RSs for beam failure detection, the WTRU may determine (e.g., detect) beam failure of partial beam-BFR.
      For example, if a number of failed BFD-RSs (e.g., by measuring beam qualities of BFD-RSs) is larger than the number of RSs for beam failure detection, the WTRU may process partial beam-BFR procedure. If the number of failed BFD-RSs is equal to the number of configured BFD-RSs, the WTRU may process all beam-BFR procedure.
One or more counters, and/or one or more thresholds of the one or more counters for partial beam-BFR and all beam-BFR.
   The counters and maximum numbers may be one or more of following:
      BFD counters and thresholds of the BFD counters.
         The WTRU may be configured with a first counter and a first threshold. If the WTRU detects all beam-BFR (e.g., all configured BFD-RSs fail), the WTRU may increase the first counter. If the first counter is equal to or larger than the first threshold, the WTRU may determine one or more best beams based on one or more NCB-RSs.
         The WTRU may be configured with a second counter and a second threshold. If the WTRU detects partial beam-BFR (e.g., a number of failed BFD-RSs is larger than a threshold for detection), the WTRU may increase the second counter. If the second counter is equal to or larger than the second threshold, the WTRU may determine one or more best beams based on one or more NCB-RSs.
      Beam reporting counters and thresholds of the beam reporting counters.
         The WTRU may be configured with a first counter and a first threshold. If the WTRU detects all beam-BFR (e.g., all configured BFD-RSs fail) and determines one or more best beams based on one or more NCB-RSs, the WTRU may report the one or more best beams via associated uplink resources and increase the first counter. If the first counter is equal to or larger than the first threshold, the WTRU may initiate contention-based RACH procedure.
         The WTRU may be configured with a second counter and a second threshold. If the WTRU detects partial beam-BFR (e.g., a number of failed BFD-RSs is larger than a threshold for detection) and determines one or more best beams based on one or more NCB-RSs, the WTRU may report the one or more best beams via associated uplink resources and increase the second counter. If the second counter is equal to or larger than the second threshold, the WTRU may initiate contention-based RACH procedure.
      Preamble power ramping counters and thresholds of preamble power ramping counters.
         The WTRU may be configured with a first counter and a first threshold. If the WTRU detects all beam-BFR (e.g., all configured BFD-RSs fail), determines one or more best beams based on one or more NCB-RSs and reports the one or more best beams, the WTRU may receive a confirmation (e.g., by receiving a PDCCH via BFR CORESET) from a gNB. If the WTRU does not detect the confirmation, the WTRU may report the one or more best beams with increased uplink transmission power and increase the first counter. If the first counter is equal to or larger than the first threshold, the WTRU may report the one or more or more best beams with same power with previous reporting.
         The WTRU may be configured with a second counter and a second threshold. If the WTRU detects partial beam-BFR (e.g., a number of failed BFD-RSs is larger than a threshold for detection), determines one or more best beams based on one or more NCB-RSs and reports the one or more best beams, the WTRU may receive a confirmation (e.g., by receiving a PDCCH via BFR CORESET) from a gNB. If the WTRU does not detect the confirmation, the WTRU may report the one or more best beams with increased uplink transmission power and increase the second counter. If the second counter is equal to or larger than the second threshold, the WTRU may report the one or more or more best beams with same power with previous reporting.
      Initial values of one or more counters may set to zeros.
Independent timers for partial beam-BFR and all beam-BFR
   The timers may be one or more of following:
      BFD timer
         The WTRU may be configured with a first BFD counter, a first BFD threshold and a first timer. If the WTRU detects all beam-BFR (e.g., all configured BFD-RSs fail), the WTRU may increase the first counter and start the first timer. If the first counter is equal to or larger than the first threshold before expiration of the first timer, the WTRU may determine one or more best beams based on one or more NCB-RSs and report the one or more best beams to a gNB. When the first timer is expired, the WTRU may reset (e.g., set to zero) the first counter.
         The WTRU may be configured with a second BFD counter, a second BFD threshold and a second timer. If the WTRU detects partial beam-BFR (e.g., a number of failed BFD-RSs is larger than a threshold for detection), the WTRU may increase the second counter and start the second timer. If the second counter is equal to or larger than the second threshold before expiration of the second timer, the WTRU may determine one or more best beams based on one or more NCB-RSs and report the one or more best beams to a gNB. When the second timer is expired, the WTRU may reset (e.g., set to zero) the first counter.
         The one or more BFD timers may expire if a WTRU does not successfully select one or more new candidate beams within a time window.
         The one or more timers may reset if a WTRU receives a DCI with C-RNTI or MCS-C-RNTI in the recoverySearchSpaceId which is configured for BFR. In other words, the WTRU may not reset the one or more timers if the WTRU does not receive a DCI with C-RNTI or MCS-C-RNTI in the recoverySearchSpaceId.
      BFR timer
         The WTRU may be configured with a first timer. When the WTRU starts selection of one or more best beams and reports the one or more best beams to a gNB (e.g., random access procedure) based on detecting all beam-BFR (e.g., all configured BFD-RSs fail), the WTRU may start the first timer. If the beam reporting is successfully completed (e.g., by receiving a confirmation PDCCH from a gNB), the WTRU may stop the first timer. When the first timer is expired, a contention-based RACH procedure may be initiated.
         The WTRU may be configured with a second timer. When the WTRU starts selection of one or more best beams and reports the one or more best beams to a gNB (e.g., random access procedure) based on detecting partial beam-BFR (e.g., a number of failed BFD-RSs is larger than a threshold for detection), the WTRU may start the second timer. If the beam reporting is successfully completed (e.g., by receiving a confirmation PDCCH from a gNB), the WTRU may stop the second timer. When the second timer is expired, a contention-based RACH procedure may be initiated.
Number of beam(s) based on NCB-RSs for beam reporting
   The WTRU may be configured with one or more values indicating the number of beams/RSs for beam reporting based on NCB-RSs. Based on the configured one or more values (indicating number(s) of beams/RSs) for beam reporting, the WTRU may determine and/or select one or more beams/RSs based on NCB-RSs. In an example, the number of beams may be determined and/or reported to a gNB for a new beam. All beam BFR may determine and report one or more beams to the gNB. For example, the WTRU may use a BFR procedure, and determine and/or report multiple beams based on a gNB indication.
      The WTRU may be configured with a first number (or no configuration). The WTRU may determine (e.g., select) the first number (or one if no configuration) of RSs based on NCB-RSs for beam reporting of all beam-BFR
         Based on the first number (or one if no configuration) of RSs, the WTRU may determine the first number (or one if no configuration) of uplink resources for beam reporting
      The WTRU may be configured with a second number. The WTRU may determine (e.g., select) the second number of RSs based on NCB-RSs for beam reporting of partial beam-BFR
         Based on the second number of RSs, the WTRU may determine the second number of uplink resources for beam reporting
   The WTRU may be predefined with one or more values indicating the number of beams/RSs for beam reporting based on NCB-RSs. Based on the predefined (or preconfigured) one or more values (indicating number(s) of beams/RSs) for beam reporting, the WTRU may determine and/or select one or more beams/RSs based on NCB-RSs.
      The WTRU may determine (e.g., select) the first predefined number (e.g., one) of RSs based on NCB-RSs for beam reporting of all beam-BFR.
         Based on the first number (e.g., one) of RSs, the WTRU may determine the first number (e.g., one) of uplink resources for beam reporting.
      The WTRU may determine (e.g., select) the second number (e.g., two) of RSs based on NCB-RSs for beam reporting of partial beam-BFR.
         Based on the second number (e.g., two) of RSs, the WTRU may determine the second number (e.g., two) of uplink resources for beam reporting.
Independent uplink resource sets for beam reporting
   The WTRU may determine one or more uplink resource sets for beam reporting based on a BFR type (e.g., partial beam-BFR or all beam-BFR).
      For example, the WTRU may be configured with a first resource set and a second resource set. If the WTRU detects all beam-BFR and selects one or more best beams based on NCB-RSs, the WTRU may report the one or more beams by transmitting uplink signal (e.g., PRACH, MAC CE, PUCCH and/or PUSCH) in associated uplink resources of the first resource set. If the WTRU detects partial beam-BFR and selects one or more best beams based on NCB-RSs, the WTRU may report the one or more beams by transmitting uplink signal (e.g., PRACH, MAC CE, PUCCH and/or PUSCH) in associated uplink resources of the second resource set.
      The first resource set and the second resource set may be different, and may be determined based on one or more of following:
         Uplink resources in different frequency ranges
         For example, the first resource set may be one or more uplink resources in a first frequency range (e.g., FR1 and/or FR2) and the second resource set may be one or more uplink resources in a second frequency range (e.g., above 52.6 GHz).
         Uplink resources with different periodicities
         For example, the first resource set may be one or more uplink resources with a first periodicity (e.g., 10 ms) and the second resource set may be one or more uplink resources with a second periodicity (e.g., 50 ms).
         Uplink resources with different numbers of associated beams
         For example, an uplink resource of the first resource set may be associated a first number (e.g., 1) of RSs/beams of NCB-RSs. An uplink resource of the second resource set may be associated a second number (e.g., 3) of RSs/beams of NCB-RSs.
         Uplink resources with different band types
         For example, the first resource set may be one or more uplink resources in a first band type (e.g., licensed band) and the second resource set may be one or more uplink resources in a second band type (e.g., unlicensed band).
         PRACH resources with different RACH types
         For example, the first resource set may be one or more PRACH resources with a first RACH type (e.g., normal RACH (e.g., with 4 steps)) and the second resource set may be one or more PRACH resources with a second RACH type (e.g., 2-step RACH).
         PRACH resources with different power ramping procedures/steps
         For example, the first resource set may be one or more PRACH resources with a first power ramping procedure/step and the second resource set may be one or more PRACH resources with a second procedure/step.
Independent uplink resource transmission types for beam reporting
   The WTRU may determine one or more uplink resource transmission types for beam reporting based on a BFR type (e.g., partial beam-BFR or all beam-BFR)
      For example, the WTRU may be configured with a first resource set associated with a first transmission type (e.g., single resource transmission) and a second resource set associated with a second transmission type (e.g., simultaneous transmission of multiple resources or sequential transmission of multiple resources). If the WTRU reports one or more best beams via the first resource set based on all beam-BFR, the WTRU may transmit uplink signal with the first transmission type. If the WTRU reports one or more best beams via the second resource set based on partial beam-BFR, the WTRU may transmit uplink signal with the first transmission type.
      The transmission types may be determined based on one or more of following:
         Single resource transmission based on one or more of following:
         The WTRU may transmit an uplink signal (e.g., one or more of PRACH, PUCCH, PUSCH, and MAC CE) with the configured periodicity and offset until the WTRU receives a confirmation or associated BFR timer expires.
         The WTRU may transmit an uplink signal (e.g., one or more of PRACH, PUCCH, PUSCH and MAC CE) with the configured periodicity and offset until the WTRU receives a confirmation or associated BFR counter is larger than a threshold.
      Simultaneous transmission of multiple resources based on one or more of following:
         The WTRU may simultaneously transmit one or more uplink signals (e.g., one or more of PRACH, PUCCH, PUSCH and MAC CE) with the configured periodicity and offset until the WTRU receives a confirmation or associated BFR timer expires.
         The WTRU may simultaneously transmit one or more uplink signals (e.g., one or more of PRACH, PUCCH, PUSCH and MAC CE) with the configured periodicity and offset until the WTRU receives a confirmation or associated BFR counter is larger than a threshold.
         Sequential transmission of multiple resources based on one or more of following:
         Sequential transmission with a timer and/or a counter. Referring to FIG. 8, an example of sequential transmission of multiple uplink resources with a timer and/or a counter is provided.
         The WTRU may sequentially transmit one or more uplink signals (e.g., one or more of PRACH, PUCCH, PUSCH and MAC CE) with the configured periodicity and offset until the WTRU receives a confirmation or associated BFR timer expires.
         The WTRU may sequentially transmit one or more uplink signals (e.g., one or more of PRACH, PUCCH, PUSCH and MAC CE) with the configured periodicity and offset until the WTRU receives a confirmation or associated BFR counter is larger than a threshold.
         Sequential transmission with multiple timers and/or multiple counters. Referring to FIG. 9, an example of sequential transmission of multiple uplink resources with multiple timers and/or multiple counters is provided.
         The WTRU may transmit a first uplink signal (e.g., one or more of PRACH, PUCCH, PUSCH and MAC CE) with first periodicity and first offset until the WTRU receives a confirmation or a first timer expires. If the first timer expires, the WTRU may transmit a second uplink signal (e.g., one or more of PRACH, PUCCH, PUSCH and MAC CE) with the configured second periodicity and second offset until the WTRU receives a confirmation or a second timer expires.
         The WTRU may transmit a first uplink signal (e.g., one or more of PRACH, PUCCH, PUSCH and MAC CE) with first periodicity and first offset until the WTRU receives a confirmation or a first counter is larger than a first threshold. If the first is larger than the threshold, the WTRU may transmit a second uplink signal (e.g., one or more of PRACH, PUCCH, PUSCH and MAC CE) with second periodicity and second offset until the WTRU receives a confirmation or a second counter is larger than a threshold.
Independent types of confirmation resources
   The WTRU may determine a type of confirmation resources (e.g., CORESETs and/or search spaces) based on a BFR type (e.g., partial beam-BFR or all beam-BFR)
      For example, the WTRU may be configured with first set of confirmation resources and second set of confirmation resources. If the WTRU reports one or more beams based on all beam-BFR, the WTRU may receive a confirmation message (e.g., PDCCH) based on a confirmation resource, associated with the one or more beams, of the first set of confirmation resources. If the WTRU reports one or more beams based on partial beam-BFR, the WTRU may receive a confirmation message (e.g., PDCCH) based on a confirmation resource, associated with the one or more beams, the second set of confirmation resources.
      The first set of confirmation resources and the second set of confirmation resources may be associated with different numbers of uplink resources (e.g., PRACH, PUCCH, PUSCH and MAC CE). For example, the first set of confirmation resources may be associated with a first number of uplink resources (e.g., all configured uplink resources). The second set of confirmation resources may be associated with a second number of uplink resources (e.g., 3 resources of the configured uplink resources).
Independent types of new candidate beam-reference signals (NCB-RSs)
   The WTRU may determine a type of NCB-RSs based on BFR type (e.g., partial beam-BFR or all beam-BFR).
      For example, the WTRU may be configured with a first set of NCB-RSs and a second set of NCB-RSs. If the WTRU detects all beam failure, the WTRU may determine one or more best beams based on the first set of NCB-RSs. If the WTRU detects partial beam failure, the WTRU may determine one or more best beams based on the second set of NCB-RSs.
      The first set of NCB-RSs and the second set of NCB-RSs may comprise following different types:
         Periodicity
         For example, the first set of NCB-RSs may be configured with a first periodicity (e.g., 10 ms) and the second set of NCB-RSs may be configured with a second periodicity (e.g., 50 ms).
         Transmission type
         For example, the first set of NCB-RSs may be configured with a first transmission type (e.g., periodic) and the second set of NCB-RSs may be configured with a second transmission type (e.g., semi-static or aperiodic).
         RS density
         For example, the first set of NCB-RSs may be configured with a first RS density (e.g., one RE per PRB, or three REs per PRB) and the second set of NCB-RSs may be configured with a second RS density (e.g., 1/2 RE per PRB, or one RE per PRB).

Hybrid Operation of Beam Management and all Beam BFR

In one embodiment, one or more beam failure recovery (BFR) modes may be used for a same cell, and each BFR mode may include (or be configured) with one or more of following:
Beam failure detection reference signals for the BFR mode i (e.g., q_{0,i});
   q_{0,i} may be a subset of q_{0,j}, wherein i≠j
Candidate beam reference signal list for the BFR mode i (e.g., q_{1,i});
   q_{1,i} may be a subset of q_{1,j}, wherein i≠j
RSRP thresholds to determine Out-of-Sync of a beam for the BFR mode i (e.g., Q_{out,LR,i}
RSRP thresholds to determine In-Sync of a beam for the BFR mode i (e.g., Q_{in,LR,i}
A search space (and/or CORESET) dedicated for beam failure recovery;
A BFR counter; and/or
A BFR timer.

In various embodiments, a WTRU and/or a gNB may use one or more BFR modes. The one or more BFR modes may be performed independently when configured. For example, a WTRU may be configured with a first BFR mode and a second BFR mode. The WTRU may perform BFR procedures for the first BFR mode and second BFR mode independently. A BFR procedure may include one or more of following operations or features:
Beam reference signal quality measurement (e.g., L1-RSRP or L1-SINR) with Q_{out,LR,i} and/or Q_{in,LR,i}
Beam failure detection based on q_{0,i}
New candidate beam selection or determination within
Indication of the determined or selected new candidate beam(s) to gNB
   The number of selected or determined new candidate beams may be determined based on a BFR mode. For example, a single new candidate beam may be indicated for a first BFR mode and more than one new candidate beam may be indicated for a second BFR mode.
   The uplink channel or signal for new candidate beam indication may be determined based on a BFR mode.
      In an example, a contention-free PRACH may be used for new candidate beam indication for a first BFR mode and a contention-based PRACH may be used for new candidate beam indication for a second BFR mode.
      In another example, PRACH may be used for new candidate beam indication for a first BFR mode and PUCCH may be used for new candidate beam indication for a second BFR mode.
Monitoring confirmation of the new candidate beam from gNB
   The new candidate beam confirmation may be monitored or received by UE in a different downlink channel or signal based on a BFR mode. For example, the confirmation may be monitored and/or received in a dedicated PDCCH search space for a first BFR mode and the confirmation may be monitored and/or received in a MAC-CE (or PDSCH) for a second BFR mode.

Alternatively, one or more BFR modes may be used (or configured, or determined, or selected), and an event of a BFR mode may trigger a procedure, operation, or WTRU behavior for another BFR mode. In an example, if a WTRU send a new candidate beam for a first BFR mode (e.g., all beam-BFR), the WTRU may reset BFR counter for a second BFR mode (e.g., partial beam-BFR). In another example, if a WTRU send a beam failure incident to the upper layer from PHY layer for a first BFR mode, the WTRU may hold a BFR procedure for a second BFR mode. One or more of following operations may apply:
A default BFR mode may be used, configured, or selected. If an event is occurred for the default BFR mode, a WTRU may hold or pause BFR procedures for the rest of BFR modes (e.g., stop sending beam failure incident to upper layer).
   The event may include one or more of following:
      Beam failure incident is indicated to upper layer from PHY layer;
      The beam failure detection counter (e.g., beamFailureInstnceMaxCount) hits the maximum number;
      One or more new candidate beam has been sent to upper layer; and/or
      A WTRU received a DCI in a dedicated search space for beam failure recovery (e.g., a search space with recoverySearchSpaceId) which may be referred to as BFR search space hereafter.
   Pause of (or delay) a BFR mode or BFR procedure may include at least one of following:
      Stop monitoring beam reference signal in q_{0,j};
      Stop sending beam failure incident to upper layer from PHY layer; and/or
      Stop sending new candidate beam(s) to gNB.
If a WTRU receives a DCI in a BFR search space for the default BFR mode, the WTRU may resume BFR procedure(s) for the rest of BFR modes.

In various embodiments, one or more uplink channels or signals may be used for beam failure incident indication or new candidate beam indication, and the uplink channels or signals for a BFR mode may be determined based on one or more of following. The uplink channels or signals may include any of: MAC-CE, RRC, PRACH (e.g., RACH msg 1, msg 3, msg A), PUSCH, PUCCH, PUSCH DM-RS, SR, SRS, and SR-like signal. In an example, an SR-like signal may be an uplink channel which may be reserved periodically and a WTRU may use that channel for uplink transmission when it is needed (e.g., on-off keying).
A high-layer configuration. For example, each BFR mode may be configured with an uplink channel or signal for the indication of beam failure or new candidate beam.
The BFR mode identity. Each BFR mode may be associated with an identity and the identity may be used to determine the uplink channel or signal.
The number of beams reference signal in q_{0,i}. For example, if the number of beam reference signal in q_{0,i} configured for the BFR mode is less than a threshold, a first uplink channel or signal may be used; otherwise a second uplink channel or signal may be used.
Whether beam reference signal in q_{0,i} is full set or subset. For example, a first BFR mode may have q_{0,i} with full beam reference signal and a second BFR mode may have q_{0,j} which is a subset of q_{0,i}. A first uplink channel or signal may be used for the first BFR mode and a second uplink channel or signal may be used for the second BFR mode.
The number of new candidate beams to be reported. For example, a WTRU may be configured with the number of new candidate beams to report for a BFR mode; if the number of new candidate beams to report is less than a threshold, a first uplink channel or signal may be used; otherwise, a second uplink channel or signal may be used.

In one embodiment, a WTRU may be triggered to perform one or more procedures, operations, and/or WTRU behaviors when one or more triggering conditions are met based on BFR configuration. The one or more triggering conditions may include any of:
A subset of beam reference signals in q_{0,i} is failed (e.g., the measurement of the beam reference signal is below a threshold), wherein the subset may be determined based on one or more of following:
   (pre-)configured via a higher layer signaling (e.g., RRC, MAC-CE)
   Implicitly determined based on CORESET pool index.
      For example, when the beam reference signals associated with CORESETs with CORESETpoolIndex=0 are failed.
   The first N beam reference signals in q_{0,i} are failed, where N may be a predefined or preconfigured number.
   Beam reference signal associated with a specific CORESET-id is failed (e.g., beam reference signal associated with CORESET-id=0).
A number of beams failed in q_{0,i} is larger than a threshold. For example, a WTRU may measure beam quality of beam reference signals in q_{0,i} and the number of beams failed is larger than a threshold.
   The threshold may be a predefined number or a configured value via a higher layer signaling.
At least one new candidate beam is found, selected, or determined in q_{1,i}. For example, a WTRU may measure beam reference signals in q_{1,i} and at least one of the beam reference signals in q_{1,i} meets a predefined condition (e.g., its measurement may be higher than a threshold)
   The threshold for the beam measurement may be Q_{in,LR,i}
A timer expired. For example, the timer may be reset when one or more triggering conditions described herein are met.
   The timer value may be (pre-)configured or predefined.

In various embodiments, one or more WTRU behaviors, which may be triggered by one or more conditions described herein, may include any of:
A WTRU may report information related to a beam failure.
   For example, a WTRU may report any of: 1) the failed beam information (e.g., the subset of beam reference signals in q_{0,i}), 2) beam failure incident, 3) new candidate beam information, and 4) measurement result of subset or all of beam reference signals in q_{0,i}
      The measurement result may be L1-RSRP, L1-SINR, or CQI.
      The uplink channel or signal for the WTRU reporting may be at least one of: MAC-CE or RRC, PUCCH, PRACH, scheduling request (SR)-like uplink resource, SRS, PUSCH, and/or PUSCH DM-RS.
   The uplink channel or signal may be determined based on the WTRU report type. For example, MAC-CE may be used for a first UE report type, PRACH may be used for a second UE report type, PUCCH may be used for a third UE report type, and so forth. A WTRU report type may include one or more of following parameter and each UE report type may include different set of the parameters:
      Failed beam information in q_{0,i}
      Beam failure incident (e.g., beam failure is detected) Beam failure incident may be indicated when the number of beams failed in q_{0,i} is larger than a threshold, wherein the threshold may be (pre-)configured or determined based on configuration of CORESETs, BWP, or a cell
      New candidate beam information in
      Beam group information wherein one or more beam failure is detected
      Measurement results of all or subset of beam reference signals in q_{0,i}
   The uplink channel or signal for WTRU reporting may be determined based on the number of beams failed. For example, if all beams are failed in q_{0,i}, PRACH or SR-like uplink resource may be used; if a subset of beams is failed in q_{0,i}, MAC-CE, PUSCH, or PUCCH may be used.
A WTRU may start beam pairing procedure with periodic CSI-RS and/or SSB.
A WTRU may declare a radio link failure (RLF) and start performing a RLF procedure.
A WTRU may start a contention-based random access procedure.
A WTRU may fallback to a default BWP (or initial BWP) if the WTRU operates in another BWP
   The fallback may occur if the WTRU detected beam failure of all or subset of beams in q_{0,i} and there is no new candidate beam determined or selected in q_{1,i}
   The fallback may occur if a timer expires after the WTRU detected beam failure of all or subset of beams in q_{0,i} and/or no new candidate beam determined or selected in
A WTRU may start searching another cell (e.g., a cell currently not a serving cell) or a transmission/reception point (TRP) (e.g., a TRP currently not a serving TRP).
A WTRU may send a scheduling request for sending WTRU reports, and the WTRU reports may be carried in MAC-CE or PUSCH.

PRACH Resource Selection Based on BFR Case(s)

In various embodiments, a TRP may be interchangeably used with a CORESET pool, a CORESET pool ID, a search space pool, a search space pool ID, a TRP ID and/or a higher layer index.

In various embodiments, one or more of following configurations may be used for BFR:
A WTRU may be configured with one or more of beam failure detection (BFD) RSs (e.g., q̅₀)
   Based on the one or more BFD-RSs, the WTRU may be configured with an anchor beam of the one or more BFD-RSs and secondary beams of the one or more BFD-RSs
      For example, the WTRU may receive an indication of the anchor beam from a gNB.
      For example, the anchor beam may be a beam for CORESET 0.
      For example, other beams than the anchor beam of the one or more BFD-RSs may be secondary beams.
A WTRU may be configured with one or more counters and one or more maximum numbers of the one or more counters. The counters may be one or more of following:
   BFD counters and thresholds for the BFD counters.
   Beam reporting counters and thresholds for the beam reporting counters.
   Preamble power ramping counter and thresholds for preamble power ramping counter.
A WTRU may be configured with one or more timers. The one or more timers may include one or more of a BFD timer and/or a BFR timer.
A WTRU may be configured with one or more sets of new candidate beam (NCB) RSs (e.g., q̅₁)
   Each RS of NCB-RSs may be associated with one or more uplink resources (e.g., PRACH, PUCCH, PUSCH, and/or SRS).
A WTRU may be configured with uplink resources (S) for new candidate beam indication, wherein S is one or more uplink resources to indicate new candidate beam.
A WTRU may be configured with search spaces (C) for receiving one or more confirmation random access response of BFR, wherein Cᵢ is a set of search spaces to receive random access response for BFR.

In one embodiment, a WTRU may determine two or more best beams (e.g., from NCB-RSs) for beam reporting based on one or more of following operations.

In an example, a WTRU that operates and receives two or more simultaneous beams that may belong to different TRPs may have an anchor beam, the strongest or best quality one for example, and secondary beams, it may be configured with specific PRACH resources related to BFR that would allow BFR operations with separate beams transmitted from different TRPs.

In another example, the WTRU may be configured with a unique PRACH resource for BFR for the anchor beam, a different PRACH resource for the secondary beam/TRP, and a different PRACH resource for a beam group, meaning it will imply that a beam or a group of beam failed or even all beams failed, and thus the beam recovery may imply one beam or multiple beams.

As the WTRU is measuring the beams, the WTRU may be also estimating the hypothetical PDCCH BLER on each one through the RSRP levels against the RLF pair of thresholds Qᵢₙ, Qₒᵤₜ per beam. In some cases, the anchor beam may fail, or a secondary beam failure, or a group of beam failure, or full beam failure, meaning a total RLF.

In various embodiments, a PRACH resource may be defined as a specific preamble, on a specific time domain location, on a specific resource specific frequency domain, and/or a PRACH preamble type (or a PRACH preamble length). The PRACH resources can be mapped for different combinations of BFR as partial BFR (e.g., partial beam BFR) or full BFR (e.g., all beam BFR).

Table 1 illustrates an example of PRACH resource determination based on the measurement/failure status of an anchor beam and one or more secondary beams.

TABLE 1
Example of PRACH resource mapping for different BFR cases

| Selected PRACH Resources | Anchor Beam | Secondary Beam |
|---|---|---|
| PRACH resource 1 | Anchor beam fail | Secondary beams OK |
| PRACH resource 2 | Anchor beam OK | One secondary beam fail |
| PRACH resource 3 | Anchor beam OK | Group of secondary beams failed |
| PRACH resource 4 | Anchor beam OK | All secondary beams failed |
| PRACH resource 5, 6, 7 | Anchor beam fail | All secondary beams failed |

In one embodiment, a WTRU may determine PRACH resource mapping based on different BFR cases. Multiple possible outcomes may be envisioned when multiple beams are in use or being candidates.

For instance, a configured PRACH resource may be reserved for anchor beam failure, while the secondary beams coming from different TRPs may be still operational. When this kind of failure happens, as a partial RLF, based on the anchor cell Qₒᵤₜ threshold, the WTRU may use this specific reserved PRACH resource that would allow to replace only the anchor beam with another one while still receiving the other ones in good health. In this situation, UE uses the PRACH resource, reserved for anchor cell while the secondary beams are still in good quality, indicating the best beam replacement for the anchor beam on that particular cell. This will implicitly tell the gNB that the other beams are still operating normally. Upon transmission of the BFR PRACH the WTRU will start monitoring the PDCCH/CORESET associated with the new beam for confirmation.

As a secondary effect, when no UL simultaneous transmissions are allowed or possible, it may be possible for the WTRU to hold back the other UL transmissions on the secondary beams for prioritizing the anchor beam replacement.

In one embodiment, when a secondary beam fails, the WTRU may use a specific RACH resource mapped for secondary single beam failure while the anchor beam is operating normally. In this case, as the overall radio link is still operational, the WTRU may use a PRACH occasion mapped for this beam replacement that would not overlap with any UL grants on another beams. Thus, the WTRU may have a defined/configured time window to pick a PRACH resource in time domain. A constraint rule may be, for example, when the WTRU arrive at the last possible PRACH resource in the partial beam-BFR time window when it is allowed to drop any other uplink transmissions on other beams to start the partial beam-BFR process on that particular beam. However, due to some other possible constraints/priorities in the ongoing uplink transmissions, and the time window for partial beam-BFR is exceeded, the WTRU may use the normal event type signaling to signal the secondary beam dropping process to the anchor beam/TRP. Upon transmission of the BFR related PRACH resource, the WTRU may start monitoring the PDCCH/CORESET associated with the new beam.

In the case of an inter-cell TRP, the anchor cell may reconfigure the WTRU, for example, upon reception of an event type signaling (e.g., an Ax event).

In the case of multiple beams operation/monitoring, and when all the active beams fail, the WTRU may use a specific set of reserved PRACH resources that can implicitly signal all beam-BFR operation on multiple beams. In this case, to speed up the process, following the example of PRACH resource reservation from the Table 1, the WTRU may send PRACH on the best beam first, using PRACH resource 5. If the WTRU fails with PRACH resource 5, the WTRU may try the second best beam using PRACH resource 6. If PRACH resource 6 fails, the WTRU may try PRACH resource 7 and this may be on possibly different TRPs. For each BFR trial the WTRU may start PDCCH/CORESET monitoring associated with the replacement beam(s). Upon expiration of the BFR time window for one beam, the WTRU may continue with the next beam BFR trial. The time window for BFR may be defined as the time required to try PRACH resource with all steps to ramp up to a maximum power, plus the time for PDCCH monitoring after the last shot/trial.

The WTRU may consider the first received PDCCH/DCI as an answer/response (e.g., confirmation and/or receipt) to a PRACH transmission for a new beam as the new anchor beam. The group beam recovery may have defined a timeout that can be a temporal limit as a timer or the depletion of all reserved PRACH resources for all-beam BFR or RLF. Upon timing out the all-beam BFR the WTRU may return to cell search, moving from connected mode to idle mode.

Efficient RS/Resource Utilization Via Dynamic Activation/Deactivation/Indication

In order to efficiently utilize resources, one or more of following configurations may be used for beam failure recovery:
A WTRU may be configured with one or more sets of BFD-RSs (e.g., q_{0,i}), where i may be an ID of a set of BFD-RSs or a BFR set.
A WTRU may be configured with one or more sets of NCB-RSs (e.g., q_{1,j}), where j may be an ID of a set of NCB-RSs or a BFR set.
   Each NCB-RS in the set may be associated with one or more uplink resources (e.g., PRACH, PUCCH, PUSCH, and/or SRS).
A WTRU may be configured with one or more sets of uplink resources (Sₖ) for new candidate beam indication, where k may be an ID of a set of uplink resources or a BFR set.
A WTRU may be configured with one or more sets of search spaces (Cᵢ) for receiving one or more confirmation random access response of BFR, where/may be an ID of a set of search spaces or a BFR set.
A WTRU may be configured with one or more BFD counters and corresponding one or more thresholds. Each BFD counter of the one or more BFD counters may be associated with a BFR set.
A WTRU may be configured with one or more BFR counters and corresponding one or more thresholds. Each BFR counter of the one or more BFR counters may be associated with a BFR set
A WTRU may be configured with one or more BFD timers. Each BFD timer of the one or more BFD timers may be associated with a BFR set
A WTRU may be configured with one or more BFR timers. Each BFR timer of the one or more BFR timers may be associated with a BFR set

In one embodiment, a WTRU may be configured with set pairs and each set pair of the set pairs may comprise one or more of following:
BFD-RS set (q̅_{0,i})
NCB-RS set (q̅_{1,j},)
UL resource set (Sₖ)
Search space set (Cᵢ)
BFD counter
BFR counter
BFD timer
BFR timer

In some examples, the set pairs may be referred to as BFR set R_{set,m}, where m may be an ID of a BFR set.

In one embodiment, a WTRU may determine one or more BFR sets of the one or more BFR sets for BFR operation based on one or more of following:
Activation/deactivation of BFR set (R_{set,i})
Activation/deactivation of BFD-RS set (q̅_{0,i})
Activation/deactivation of NCB-RS set (q̅_{1,i})
Activation/deactivation of UL resource set (Sᵢ)
Activation/deactivation of Search space set (Cᵢ)

In various embodiments, one or more of the activation/deactivation processes discussed above may be based on one or more of following:
Explicit indication
   For example, a WTRU may receive an explicit indication of a set (e.g., a set ID) from a gNB. If the WTRU receives a first ID, the WTRU may activate/deactivate a first set associated with the first ID. If the WTRU receives a second ID, the WTRU may activate/deactivate a second set associated with the second ID.
Toggling
   For example, if a WTRU receive a bit toggling indication (e.g., from 0 to 1), the WTRU may switch from a first set to a second set for BFR operation.
Indication of activation and deactivation
   For example, a first indication (e.g., 1) of a field may indicate activation and a second indication (e.g., 0) of the field may indicate deactivation.

In various embodiments, the singling of the activation/deactivation may be based on one or more of following:
DCI
   DCI may comprise one or more of following:
      UE-specific DCI
      Group DCI
   DCI may be scrambled with a specific RNTI for set activation/deactivation
      The specific RNTI may be predefined or configured (e.g., via RRC)
MAC CE
   MAC CE may be identified with LCID
DCI and MAC CE
   A WTRU may receive activation/deactivation messages via MAC CE and indication via DCI. For example, a WTRU may be configured with a first set, a second set and a third set. The WTRU may receive a message activating the first set and the second set and deactivating the third set (e.g., via MAC CE).
   Based on the activation/deactivation, the WTRU may receive an indication of a set for BFR operation (e.g., via DCI). For example, if the indication indicates the first set, the WTRU may determine the first set for BFR operation. If the indication indicates the second set, the WTRU may determine the second set for BFR operation

BFR for Unlicensed/Licensed Band(s)

In various embodiments, one or more of following configurations may be used for beam failure recovery:
A WTRU may be configured with one or more of beam failure detection (BFD) RSs (e.g., go).
A WTRU may be configured with one or more counters and one or more maximum numbers of the one or more counters. The counters may be one or more of following:
   BFD counters and thresholds for the BFD counters.
   Beam reporting counters and thresholds for the beam reporting counters.
   Preamble power ramping counter and thresholds for preamble power ramping counter.
A WTRU may be configured with one or more timers. The one or more timers may be one or more of following:
   A BFD timer
   A BFR timer
A WTRU may be configured with one or more sets of new candidate beam (NCB) RSs (e.g., q̅₁).
   Each RS of NCB-RSs may be associated with one or more uplink resources (e.g., PRACH, PUCCH, PUSCH, and/or SRS).
A WTRU may be configured with uplink resources (S) for new candidate beam indication, wherein S is one or more uplink resources to indicate new candidate beam
A WTRU may be configured with search spaces (C) for receiving one or more confirmation random access response of BFR, wherein Cᵢ is a set of search spaces to receive random access response for BFR

In one embodiment, a WTRU may determine (or select) uplink resources with a specific channel type for beam reporting. The uplink resources with the specific channel type are determined (selected) from multiple uplink resources with multiple channel types for beam reporting. The multiple channel types may comprise one or more of: PRACH, PUCCH, PUSCH, and/or MAC CE. The determination (or selection) of uplink resources with the specific channel type may be based on one or more of following:
Frequency range(s)
   For example, if resources for BFR operation are located in a first frequency range (e.g., FR1 or FR2), the WTRU may determine a first uplink resources with a first channel type (e.g., PRACH). If resources for BFR operation are located in a second frequency range (e.g., FR3 or FR4), the WTRU may determine a second uplink resources with a second channel type (e.g., PUCCH, PUSCH or MAC CE).
Band type(s)
   For example, if resources for BFR operation are located in a first band type (e.g., licensed), the WTRU may determine a first uplink resources with a first channel type (e.g., PRACH). If resources for BFR operation are located in a second band type (e.g., unlicensed), the WTRU may determine a second uplink resources with a second channel type (e.g., PUCCH, PUSCH or MAC CE).

In various embodiments, the resources for BFR operation may comprise one or more of BFD-RSs, NCB-RSs and/or search spaces.

RS Group Reporting

In various embodiments, beam quality may be interchangeably referred to as (or used with) any of: RSRP, RSRQ, SINR and radio link quality (e.g., PDCCH hypothetical BLER).

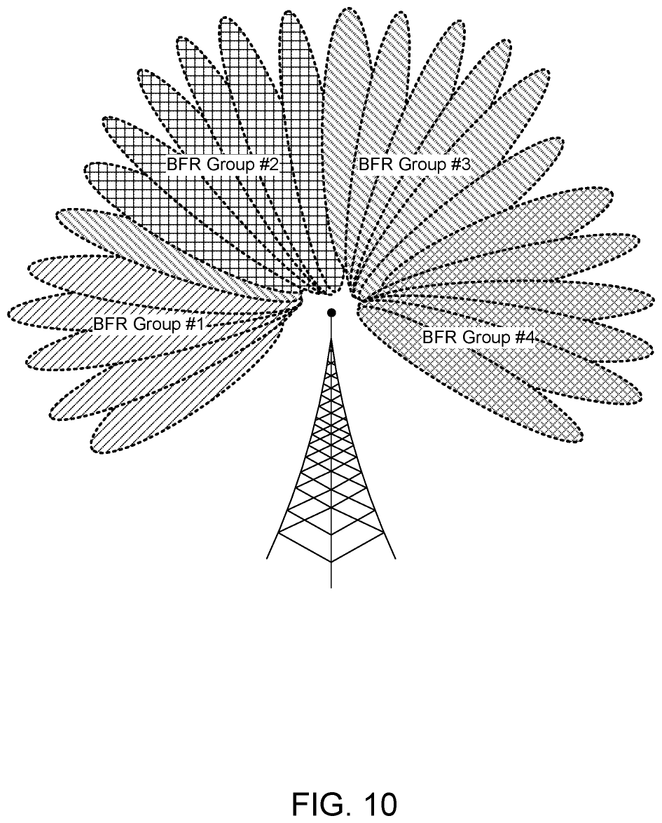

In one embodiment, referring to FIG. 10, an example of group-based beam/resource utilization for a BFR operation is provided. For example, a WTRU may dynamically monitor and assess a group of BFD-RS sets, i.e. q̅₀={q̅_{0,1}, q̅_{0,2}, . . . , q̅_{0,N}}, where each q̅_{0,i} may be a set of BFD-RSs (e.g., periodic CSI-RS resource configuration indexes and/or SS/PBCH block indexes). In other words, q̅₀ denotes all corresponding resource configurations that the WTRU may use to assess quality for the beam failure detection.

Alternatively, the RS-group may be applied to the candidate beams, wherein the WTRU may monitor and assess beam quality of a group of NCB-RS sets, i.e. q̅₁={q̅_{1,1}, q̅_{1,2}, . . . , q̅_{1,M}}, where each q̅_{1,i} may be a set of NCB-RSs (e.g., periodic CSI-RS resource configuration indexes and/or SS/PBCH block indexes).

Resource group may be applied to the uplink resources, wherein the WTRU may report one or more best beams based on the candidate beams, i.e. s̅={s̅₁, s̅₂, s̅_{K}}, where each s̅ᵢ, may be an uplink resource (e.g., resource for one or more of PRACH, PUCCH, PUSCH and MAC CE).

Each set of NCB-RSs may be associated with an uplink resource (e.g., resource for one or more of PRACH, PUCCH, PUSCH and MAC CE).

In one embodiment, a set of reference signal sets may be configured based one or more of following:
Reference signal set ID (e.g., BFD-RS set ID or NCB-RS set ID)
   A WTRU may be configured with RSs comprising a RS set ID. Based on the RS set ID, the WTRU may determine a RS set. For example, the WTRU may be configured with a first RS with a first RS set ID and a second RS with a second RS set ID. Based on the RS set IDs, the WTRU may determine the first RS as a first RS set and the second RS as a second RS set.
Reference signal ID
   A WTRU may be configured with RSs with RS ID. Based on the RS ID, the WTRU may determine a reference signal set. For example, the WTRU may be configured with a RS with a RS ID. If the RS ID is smaller than (or equal to) a threshold, the WTRU may determine the RS as a first group. If the RS ID is larger than the threshold, the WTRU may determine the RS as a second group.
      The threshold may be determined based on one or more of following:
         Predefined value
         UE capability and gNB indication (e.g., via RRC)
         Configured number of RSs
         For example, if the configured number of RSs is smaller than (or equal to) X (e.g., 8), the WTRU may determine the threshold value as a first value (e.g., 1). If the configured number of RSs is larger than X (e.g., 8), the WTRU may determine the threshold value as a second value (e.g., 2).
CSI-RS resource set ID
   A WTRU may be configured with RSs comprising a CSI-RS resource set ID. Based on the RS set ID, the WTRU may determine a RS set. For example, the WTRU may be configured with a first RS with a first CSI-RS resource set ID and a second RS with a second CSI-RS resource set ID. Based on the CSI-RS resource set IDs, the WTRU may determine the first RS as a first RS set and the second RS as a second RS set.
TCI state/TCI state group
   A WTRU may be configured with RSs associated one or more TCI states. Based on the association, the WTRU may determine a RS set. For example, the WTRU may be configured with a first RS associated with first set of TCI states and a second RS associated with second set of TCI states. Based on the association, the WTRU may determine the first RS as a first RS set and the second RS as a second RS set.

In various embodiments, each RS-group may include one or more of the following: 1) beam quality thresholds and/or threshold grids to define Out-of-Sync quality levels for the radio link of the resource configurations in the RS-group; 2) beam quality thresholds and/or threshold grids to define In-Sync quality levels for the radio link of the resource configurations in the RS-group; 3) BFD counters corresponding to the thresholds and/or threshold grids; 4) BFD timers; 5) BFR counters; and/or 6) BFR timers corresponding to the thresholds and/or threshold grids.

In various embodiments, the WTRU may assess the RS-group as in a surface that changes amid the threshold grids. The WTRU may report one or more of NCB-RS sets of the group of candidate beam reference signals as the WTRU follows the trend of the changes within the RS-groups; thus, switching to the new beam can be accomplished more reliably.

In various embodiments, one or more reference signal sets may be used in the RS-group, where the configuration of the group and RS set selection may be determined based on one or more of the following:
The active beam failure detection reference configuration set may be used, configured, or selected, where q̅_{0,A} is a subset of q̅₀.
The RSRP Out-of-Sync, i.e. Q_{out,LR,A}, and In-Sync, i.e. Q_{in,LR,A} thresholds corresponding to the active beam failure detection reference configuration set may be considered as the reference threshold for the RSRP threshold grids.
One or more Out-of-Sync and In-Sync threshold grids may be used, configured, or selected, wherein each level in the grid may be a ratio of the Q_{out,LR,A} and Q_{in,LR,A}, respectively.
The resource configuration sets other than the active beam failure detection reference configuration set, within the RS-group, may be selected based on the q̅_{0,A}, wherein each radio link of the selected resource configuration sets may be within a specific range of quality level compared to the active beam failure detection reference signal RSRP thresholds, i.e. Q_{out,LR,A}, and Q_{in,LR,A}.

In various embodiments, the WTRU may detect beam failure when the radio link quality fails (e.g., all corresponding resource configurations in the active beam failure detection reference configuration set is worse than the threshold Q_{out,LR,A}). Based on the detection of the beam failure, the WTRU may report one or more sets of NCB-RSs, of the RS-group (e.g., periodic CSI-RS configuration indexes and/or SS/PBCH block indexes from the set q̅₁), based on beam quality measurements (e.g., beam quality which is larger than or equal to the Q_{in,LR,A} threshold).

In one embodiment, the reporting of the one or more sets of NCB-RSs may be based on an associated uplink resource. For example, a WTRU may be configured with a first uplink resource associated with a first set of NCB-RSs and a second uplink resource associated with a second set of NCB-RSs. If the WTRU determine the first set of NCB-RSs as best beams, the WTRU may report the best beams by transmitting uplink signals (e.g., one or more of PRACH, PUCCH, PUSCH and MAC CE) in the first uplink resource. If the WTRU determine the second set of NCB-RSs as best beams, the WTRU may report the best beams by transmitting uplink signals (e.g., one or more of PRACH, PUCCH, PUSCH and MAC CE) in the second uplink resource.

In various embodiments, a WTRU may be provided one or more search spaces associated with one or more sets of NCB-RSs for confirmation of beam reporting (e.g., receiving PDCCH). If the WTRU receives the confirmation, the WTRU may consider BFR procedure as successfully completed. If the WTRU does not receive the confirmation, the WTRU may initiate contention-based RACH procedure.

In one embodiment, a hybrid operation of all beam-BFR and partial beam-BFR may be performed by a WTRU. For example, a WTRU receives a configuration of a set of monitoring beams (BFD-RSs), a set of candidate beams (NCB-RSs), a set of uplink resources and a number of beams for partial beam failure detection (BFD). The WTRU monitors the set of BFD-RSs and determining failed BFD-RSs based on measurements. If a number of failed BFD-RSs is larger than the number of beams for partial BFD but less than the number of configured BFD-RSs (partial beam-BFR). The WTRU may determine whether partial beam-BFR has occurred more than a threshold number of times (e.g., BFD counter number of times), for example, within a time window. If the condition above is true, the WTRU may select one or more or multiple best beams based on the set of NCB-RSs and transmit multiple PRACHs associated with the selected multiple best beams. The transmission may be (or use) one of simultaneous transmission or sequential transmission. If the number of failed BFD-RS is equal to the number of configured BFD-RSs, the WTRU may perform a regular BFR operation.

In another embodiment, a WTRU may determine a mode of operation (e.g., for BFR). For example, a WTRU receives a configuration with one or more beams (e.g., a configuration of at least one BFD-RS and/or at least one NCB-RS) for BFR operation. The WTRU determines a mode of operation based on a number of the configured beams for BFR operation. If the number of configured beams is smaller than X, the WTRU supports all beam-BFR (e.g., only all beam-BFR). If the number of configured beams is larger than X, the WTRU supports hybrid operation of all beam-BFR and partial-beam BFR.

In one embodiment, interaction between all beam-BFR and partial beam-BFR may be performed by a WTRU. For example, a WTRU monitors of a set of monitoring beams. If all beams in the set fails (all beam-BFR), the WTRU pauses beam failure operation of partial beam-BFR. The WTRU may stop monitoring beams for partial beam-BFR, and/or the WTRU may stop reporting best beams for partial beam-BFR. The WTRU may resets beam failure detection counter of partial beam-BFR. If the WTRU receives confirmation a PDCCH for all beam-BFR, the WTRU may resume/restart partial beam-BFR procedure.

In one embodiment, a WTRU may determine one or more PRACH resources (e.g., UL resources) for BFR based on different BFR cases. For example, a WTRU may be configured with an anchor beam and secondary beams of BFD-RSs. The WTRU monitors, measures and/or detects the anchor beam and the secondary beams. The WTRU determines one or more PRACH resources for best beam reporting for BFR, where the WTRU determines the PRACH resource for reporting based on a measurement/failure status of the anchor beam and the secondary beams.

In one embodiment, a WTRU may be configured to activate/deactivate one or more BFR resource sets. For example, a WTRU receives a configuration of multiple BFR resource sets. The WTRU receives an indication activating a BFR resource set of the multiple BFR resource sets (e.g., via DCI or MAC CE). The WTRU processes beam failure recovery based on or using the activated BFR resource set.

Each of the following references are incorporated by reference herein: [1] 3rd Generation Partnership Project (3GPP) TS 38.213, “NR Physical layer procedures for control”, v16.1.0; [2] 3GPP TS 38.321, “Medium Access Control (MAC) protocol specification”, v16.0.0; [3] 3GPP TS 38.331, “Radio Resource Control (RRC) protocol specification”, v16.0.0; [4] 3GPP TR 38.805, “Study on New Radio access technology; 60 GHz unlicensed spectrum;” [5] 3GPP TR 38.807, “Study on requirements for NR beyond 52.6 GHz”, v16.0.0; [6] 3GPP TR 38.913, “Study on New Radio access technology; Next Generation Access Technologies;” [7] 3GPP RP-181435, “New SID: Study on NR beyond 52.6 GHz;” [8] 3GPP RP-193259, “New SID: Study on supporting NR from 52.6 GHz to 71 GHz;” [9] 3GPP RP-193229, “New WID on Extending current NR operation to 71 GHz.”

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU 102, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the representative embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (e.g., but not always, in that in certain contexts the choice between hardware and software may become significant) a design choice representing cost vs. efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting. As used herein, when referred to herein, the terms “station” and its abbreviation “STA”, “user equipment” and its abbreviation “UE” may mean (i) a wireless transmit and/or receive unit (WTRU), such as described infra; (ii) any of a number of embodiments of a WTRU, such as described infra; (iii) a wireless-capable and/or wired-capable (e.g., tetherable) device configured with, inter alia, some or all structures and functionality of a WTRU, such as described infra; (iii) a wireless-capable and/or wired-capable device configured with less than all structures and functionality of a WTRU, such as described infra; or (iv) the like. Details of an example WTRU, which may be representative of any UE recited herein, are provided below with respect to FIGS. 1A-1D.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

Throughout the disclosure, one of skill understands that certain representative embodiments may be used in the alternative or in combination with other representative embodiments.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WRTU, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits.

The data bits may also be maintained on a computer readable medium including magnetic disks, optical disks, and any other volatile (e.g., Random Access Memory (“RAM”)) or non-volatile (“e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

1. A method implemented by a wireless transmit/receive unit (WTRU) for wireless communications, the method comprising:
receiving configuration information of a first set of reference signals (RSs) for monitoring and a second set of RSs for new beam selection;
determining whether a number of the first set of RSs is larger than a threshold;
determining whether at least a subset RSs of the first set of RSs is failed;
selecting at least a first RS and a second RS from the second set of RSs, based on a determination that 1) the number of the first set of RSs is larger than the threshold and 2) at least the subset of the first set of RSs is failed;
transmitting a first uplink transmission using a first uplink resource associated with the selected first RS; and
transmitting a second uplink transmission using a second uplink resource associated with the selected second RS.

2. The method of claim 1, wherein the first set of RSs comprises one or more beam failure detection (BFD) reference signals (RSs), and the second set of RSs comprises one or more new candidate beam (NCB) RSs.

3. The method of claim 1, further comprising:
monitoring or measuring the first set of RSs; and
determining a number of failed RSs of the first set of RSs based on the monitoring or the measurements of the first set of RSs.

4. The method of claim 3, wherein at least the first RS and the second RS are selected from the second set of RSs based on the monitoring or the measurements of the first set of RSs.

5. The method of claim 1, wherein the determining that at least the subset of the first set of RSs being failed comprises determining that a number of failed RSs is equal to the number of the first set of RSs.

6. The method of claim 1, wherein the transmitting the first uplink transmission comprises transmitting the first uplink transmission on a first physical random access channel (PRACH) using the first uplink resource associated with the selected first RS.

7. The method of claim 1, wherein the transmitting the second uplink transmission comprises transmitting the second uplink transmission on a second physical random access channel (PRACH) using the second uplink resource associated with the selected second RS.

8. The method of claim 1, wherein the first uplink transmission comprises a first beam recovery request message, and the second uplink transmission comprises a second beam recovery request message.

9. The method of claim 1, further comprising:
selecting the first RS from the second set of RSs, based on a determination that 1) the number of the first set of RSs is larger than the threshold and 2) a number of the subset of the first set of RSs is less than the number of the first set of RSs; and
transmitting the first uplink transmission using the first uplink resource associated with the selected first RS.

10. The method of claim 9, wherein the number of the subset of RSs being failed is larger than a number of beams for partial beam failure detection (BFD) and less than the number of the first set of RSs for monitoring.

11. The method of claim 1, further comprising:
selecting the first RS from the second set of RSs, based on a determination that 1) the number of the first set of RSs is not larger than the threshold and 2) a number of failed RSs of the first set of RSs is equal to the number of the set of RSs; and
transmitting the first uplink transmission using the first uplink resource associated with the selected first RS.

12. The method of claim 1, wherein the configuration information comprises an indication of a set of uplink resources, wherein the set of uplink resources includes the first uplink resource and the second uplink resource.

13. The method of claim 1, further comprising:
receiving, in downlink control information (DCI), an activation indication of a third set of RSs for beam failure recovery (BFR), wherein the activation indication indicates an identifier associated with the third set of RSs for BFR; and
selecting the third set of RSs for BFR based on the received activation indication.

14. The method of claim 1, further comprising:
receiving, in a Medium Access Control (MAC) Control Element (CE) message, an activation indication of a fourth set of RSs for beam failure recovery (BFR), wherein the activation indication indicates an identifier associated with the fourth set of RSs for BFR; and
selecting the fourth set of RSs for BFR based on the received activation indication.

15. A wireless transmit/receive unit (WTRU) comprising:
a receiver configured to receive configuration information of a first set of reference signals (RSs) for monitoring and a second set of RSs for new beam selection;
a processor configured to:
determine whether a number of the first set of RSs is larger than a threshold,
determine whether at least a subset of the first set of RSs is failed, and
select at least a first RS and a second RS from the second set of RSs, based on a determination that 1) the number of the first set of RSs is larger than the threshold and 2) at least the subset of the first set of RSs is failed; and
a transmitter configured to:
transmit a first uplink transmission using a first uplink resource associated with the selected first RS, and
transmit a second uplink transmission using a second uplink resource associated with the selected second RS.

16. The WTRU of claim 15, wherein the first set of RSs comprises one or more beam failure detection (BFD) reference signals (RSs), and the second set of RSs comprises one or more new candidate beam (NCB) RSs.

17. The WTRU of claim 15, wherein the processor is further configured to determine that a number of failed RSs of the first set of RSs is equal to the number of the first set of RSs.

18. The WTRU of claim 15, wherein the transmitter is further configured to:
transmit the first uplink transmission on a first physical random access channel (PRACH) using the first uplink resource associated with the selected first RS; or
transmit the second uplink transmission on a second PRACH using the second uplink resource associated with the selected second RS.

19. The WTRU of claim 15, wherein the first uplink transmission comprises a first beam recovery request message, and the second uplink transmission comprises a second beam recovery request message.

20. The WTRU of claim 15, wherein the processor is further configured to select the first RS from the second set of RSs, based on a determination that 1) the number of the first set of RSs is larger than the threshold and 2) a number of the subset of the first set of RSs is less than the number of the first set of RSs.
